(19) United States
(12) Patent Application Publication
(10) Pub. No.: US 2017/0220746 A1
(43) Pub. Date: Aug. 3, 2017

(54) SYSTEM AND METHOD FOR PROVIDING ACCESS TO ELECTRONIC MEDICAL RECORDS

(71) Applicant: COMPLETE CONCUSSION MANAGEMENT INC., Toronto (CA)

(72) Inventor: Cameron MARSHALL, Toronto (CA)

(21) Appl. No.: 15/501,341

(22) PCT Filed: Aug. 5, 2015
(86) PCT No.: PCT/CA2015/050738

§ 371 Date: Feb. 2, 2017

Related U.S. Application Data
(60) Provisional application No. 62/033,183, filed on Aug. 5, 2014.

(51) Int. Cl. G06F 19/00; G06F 21/62

(52) U.S. Cl. CPC G06F 19/323; G06F 21/6245

(57) ABSTRACT

Methods and systems are disclosed for providing access to numerous users to patients' electronic medical records. The systems and methods enable multiple users to submit injury reports for a patient to the patient's healthcare providers for diagnosis, treatment and reporting. The systems and methods facilitate interaction between medical practitioners and athletes during treatment and recovery regimes.

### TECHNICAL FIELD

The following relates generally to a system and method for sharing access to electronic medical records.

### BACKGROUND

Recent medical developments have led to greater emphasis on the reporting and monitoring of sports- and activity-related injuries. Whereas head injuries and concussions were previously considered minor, research has shown that, if left untreated and undetected, repeated concussions can lead to future impediments and illness for affected patients.

Multiple parties may be involved in reporting and treating injuries, and in monitoring patient progress.

### SUMMARY

In embodiments, a system is described. The system provides a plurality of users with varying levels of access to stored medical record data for a plurality of patients. The system comprises a database to store the medical record data and a plurality of access permissions, and the database identifies each patient's medical record data by an anonymous identifier for the patient; the anonymous identifier has an associated anonymous token. The system further comprises a server computer communicatively coupled to the database and accessible by a plurality of client computing devices. The server computer is configured to: upon receiving from one of the client computing devices a request containing a user identity of one of the users and the anonymous token of one of the patients; identify, from the user identity, to which one of a plurality of classes of the users the user belongs; retrieve an access permission for the class from amongst the plurality of access permissions stored in the database, each access permission defining which subset of each patient's medical record data can be read or written by the class to the medical record data identified by the anonymous identifier associated to the anonymous token in the request; and exchange medical record data identified in the request between the computing device and the database according to the access permission and writing any data from the computing device to the database.

In further embodiments, the access permission for a class comprising coaches, teachers or trainers permits any user from the class to write an injury report to the medical record data identified by the anonymous identifier or the anonymous token. The anonymous token may be discernible from a physical tag attachable to the patient or belongings of the patient. The physical tag may display a visual code applied to the surface of the physical tag, while the computing device of the user may be configured to read the code and discern the token from the code. The visual code may be a QR code, a UPC code, or an alphanumeric code. Alternatively, the physical tag may emit an RFID, while the computing device of the user may be correspondingly configured to read the RFID and discern the token from the RFID.

In still further embodiments, the access permission for a class comprising coaches, teachers or trainers further permits any user from the class to build a roster comprising a plurality of patients by entering the token for each patient in the roster, and to simultaneously receive on the computing device of the user a status indication from the medical record data for each of the plurality of patients in the roster. The status indication indicates a stage of recovery for the athlete, such as, for example, one of the stages of recovery from a concussion. The computing device of the user may be configured to display a list of the patients in the roster alongside the status indication of each patient. The status indication for each user may be discernible to indicate a permissible level of activity, whether physical or cognitive, for the user. Further, the server computer may be configured to select the level of cognitive or physical activity based on a stage of recovery selected by one of the users from amongst a class comprising medical practitioners. The access permission for at least the class comprising coaches, teachers or trainers may further permit the user to submit a request for reassessment for any patient in the roster to the database, while the server computer may be configured to transmit the request for reassessment to any user who belongs to the class comprising medical practitioners and who is permitted to see the request.

In still further embodiments, the access permission for the class comprising coaches, teachers, trainers and the class comprising patients permits any user from either class to contribute further reporting to the medical record data upon the user receiving and agreeing to a request for the further reporting from another user belonging to a class comprising medical practitioners.

The server may be further configured to aggregate medical record data across the plurality of patients whose medical record data is stored in the database, and provide the aggregated medical record data without providing medical record data from which the patients' identities may be discerned, to at least one of the computing devices upon receiving a request from the computing device.

In at least another embodiment, a computer-implemented method is provided. The method provides a plurality of users with varying levels of access to stored medical record data for a plurality of patients. The method comprises storing medical record data and a plurality of access permissions in a database, the database identifying the medical record data for each patient by an anonymous identifier for the patient, the anonymous identifier having an associated anonymous token. The method further comprises, by a server computer, upon receiving from one of a plurality of client computing devices a request containing a user identity of one of the users and the anonymous token of one of the patients: identifying, from the user identity, to which one of a plurality of classes of the users the user belongs; retrieving an access permission for the class from amongst the plurality of access permissions stored in the database, each access permission defining which subset of each patient's medical record data can be read or written by the class to the medical record data identified by the anonymous identifier associated to the anonymous token in the request; and exchanging medical record data identified in the request between the computing device and the database according to the access permission and writing any data from the computing device to the database.

In the methods, the access permission for at least the class comprising coaches, teachers or trainers may permit any user from the class to write an injury report to the medical record data identified by the anonymous identifier associated to the anonymous token in the request. The anonymous token may be discernible from a physical tag attachable to the patient or belongings of the patient. The physical tag may display a visual code applied to the surface of the physical tag while the computing device of the user may be configured to read the code and discern the token from the code. The visual code may be a QR code, a UPC code, or an alphanumeric code. Alternatively, the physical tag may emit an RFID, while the computing device of the user is configured to read the RFID and discern the token from the RFID.

In the methods, the access permission for at least the class comprising coaches, teachers or trainers may further permit any user from the class to build a roster comprising a plurality of patients by entering the token for each patient in the roster, while the computing device of the user may receive a status indication from the medical record data for each of the plurality of patients in the roster. The computing device of the user may be configured to display a list of the patients in the roster and the status of each patient based on the status indication. The server computer may further select the status indication based on a stage of recovery selected by one of the users from amongst a class comprising medical practitioners. The access permission for at least the class comprising coaches, teachers or trainers may permit the user to submit a request for reassessment for any patient in the roster to the database, while the server computer may further transmit the request for reassessment to any user who belongs to the class comprising medical practitioners and who is permitted to see the request.

In the method, the access permission for at least the class comprising coaches, teachers, trainers and the class comprising patients may permit any user from either class to contribute reporting to the medical record data upon the user receiving and agreeing to a request for the reporting from another user belonging to a class comprising medical practitioners.

The method may further comprise the server computer aggregating medical record data across the plurality of patients whose medical record data is stored in the database, and providing the aggregated medical record data without providing medical record data from which the patients' identities may be discerned, to at least one of the computing devices upon receiving a request from the computing device.

These and other aspects are contemplated and described herein. It will be appreciated that the foregoing summary sets out representative aspects of systems and methods for sharing access to electronic medical records to assist skilled readers in understanding the following detailed description.

### DESCRIPTION OF THE DRAWINGS

A greater understanding of the embodiments will be had with reference to the Figures, in which:

FIG. 1 is a block diagram of a system for providing access to electronic medical records;

FIG. 2 is a flowchart illustrating a method of generating a coach or trainer user profile;

FIG. 3 is a flowchart illustrating a method of generating an athlete or patient user profile;

FIGS. 4A to 4C illustrate embodiments of user identifier tokens;

FIGS. 5A to 5J illustrate embodiments of a coach- or trainer-facing user interface;

FIGS. 6A to 6M illustrate embodiments of an athlete- or parent-facing user interface; and

FIGS. 7A to 71 illustrate embodiments of a medical practitioner-facing interface.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic discs, optical discs, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile discs (DVD) or other optical storage, magnetic cassettes, magnetic tape, magnetic disc storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates to systems and methods for providing a plurality of users with varying levels of access to medical record data for a plurality of patients. In aspects, the systems and methods enable sharing of patient data between various users, including injury and incident reports, treatment plans and patient reporting. In embodiments, the following systems and methods distinguish between varying classes of users, as well between users within any given class, to ensure that each user's access to read and/or write to a patient's medical record is appropriate to the user's class and the patient's desire to share such information with the user.

It has been found that the long-term damage caused by activity-related injuries may be mitigated by early reporting and treatment of said injuries. In many sports, for example, athletes are prone to concussions and other injuries calling for early management by trained medical professionals (which may alternatively be, more broadly, healthcare providers, and the two terms are used interchangeably herein). These injuries may be exacerbated if athletes prematurely return to play, potentially leading to serious acute adverse events as well as long-term degenerative outcomes. Determining whether an athlete should return to play frequently requires assessment by an off-site medical practitioner, as well as reporting by the athlete or third parties, such as, for example, trainers, teachers, coaches, parents and officials.

It has been further found that certain types of injuries, particularly concussions, are cumulatively acute, whereas a single occurrence may tend to be relatively benign. Therefore, successive reporting of individually minor injuries for any given athlete may lead to improved accuracy in diagnosing the severity of a given injury sustained by the athlete.

Long-term harm suffered as a result of an injury may also be mitigated by facilitating interaction between a patient and medical practitioners involved in treating the patient. For example, when a patient provides timely reporting to her medical practitioners, the medical practitioners may be better able to monitor the effectiveness and progress of treatment programmes. Medical practitioners may further provide the patient with updated prognoses, treatment programmes and/or suggestions that are responsive to patient reporting. In some cases, this interactive dialogue may be further enhanced when other parties related to the patient are involved. In certain scenarios, providing third parties with the ability to report health related incidents encountered by affected patients may increase the frequency of incident reporting and enhance patient adherence to treatment programmes.

By providing patients (alternatively referred to herein as “athletes”), third parties, and medical practitioners with access to electronic medical records, interactivity between the parties may be enhanced, and the patient's “circle of care” may be enlarged and more efficiently exploited. Further, data entered by the aforementioned parties may prove useful for research purposes.

Patient medical record data, or electronic medical records (EMRs), contain patient data which patients, lawmakers and healthcare providers may wish to keep private from all but a very limited subset of parties. Different parties may require varying levels of access to EMRs in order to provide meaningful contributions to patient welfare.

Systems and methods are described herein for providing access to electronic medical records to various parties involved in the treatment of patients. Embodiments are described particularly with respect to numerous exemplary scenarios, in which the actors using the systems and methods are described variously as coaches, trainers, parents and medical practitioners; however, it will be appreciated that the systems and methods described herein are applicable to other scenarios, such as, for example, workers, supervisors, lead hands, management, and family members of workers, or students, teachers, school administrators and students' families. Further, in embodiments, the systems and methods facilitate the sharing of EMRs with researchers.

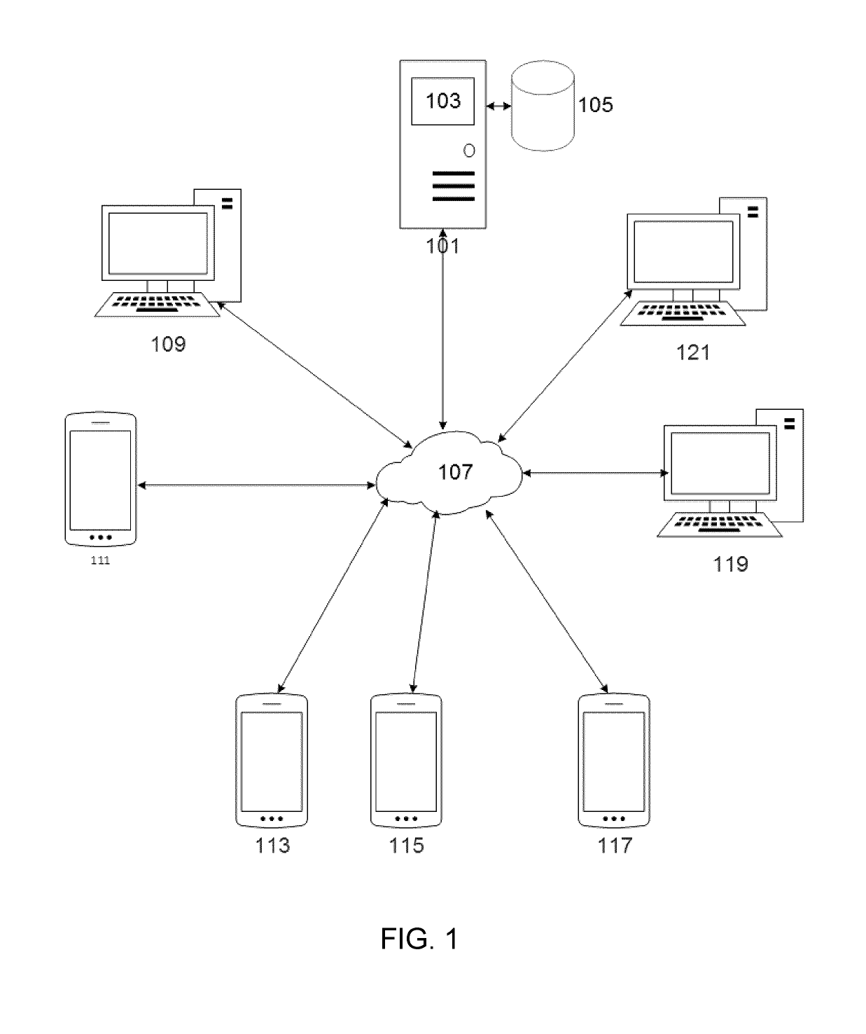

Referring now to FIG. 1, the system comprises a server 101 hosting an EMR utility 103 for providing access to an EMR database 105. The EMR database 105 stores patient medical records, including, for example, baseline records, incident records, prescriptions and treatment programmes. The EMR database 105 further stores a plurality of access permissions which define which types or classes of users may read or write data to the EMR database 105. The EMR database may be distributed, so that the access permissions and the patient medical records are stored in different databases. Alternatively, all storage for the system may be in a single database. The server 101 may be linked by a network 107, such as the Internet, to one or more of the computing devices shown, such as, for example, a home medical practitioner computer 109, an away medical practitioner computer 121 (where ‘home’ refers to an athlete's principal medical practitioner, and ‘away’ refers to a medical practitioner that an athlete may visit when he is unable to visit his principal or home medical practitioner, as described herein in greater detail), an observer's mobile device 111, an athlete's mobile device 113, a parent's mobile device 115, an athletic trainer's or coach's mobile device 117 and a researcher's computer 119.

The EMR utility 103 enables the various computing devices depicted in FIG. 1 to access the EMR database, whether to contribute or retrieve patient data, depending on the permissions related to the access profile of the user utilizing the computing device. Although the EMR utility 103 may run as a single utility, in embodiments, it will present as different sub-utilities, including a coach/trainer/teacher sub-utility, a parent/athlete sub-utility, and a medical practitioner sub-utility, each having distinct functionalities depending on the identity and access level of the user attempting to access the utility. The EMR utility may be hosted on the server 101, as shown, and accessed by the various users as a webpage, or the utility may be hosted on each or some of the devices shown in FIG. 1.

The computing devices are shown in FIG. 1 as being either a desktop computer or mobile telephone, or standalone server, but it will be appreciated that the devices may be embodied by any suitable computing device or combination of computing devices, such as, for example, desktop computer, laptop computer, mobile telephone, tablet or server computer. Each device comprises a processor and memory, the memory having stored thereon computer instructions which, when executed, cause the device to execute tasks described herein. As described, the EMR utility may be accessed by a web portal generating web pages accessible by web browsers or web-enabled applications executed on the devices.

The network 107 may provide for wired or wireless communication between the server and the devices. Wireless communication may be provided by any suitable protocol, such as, for example, IEEE 802.11, GPRS, 3G, 4G, and LTE. The network 107 may be the Internet.

The EMR database 105 is configured to identify each patient's EMR by an anonymous unique identifier for the patient, as well as an anonymous token association with the unique identifier for each patient is associated with a token, which serves to anonymise the patient's medical information, whether that information is stored in the EMR database 105 or is provided to the server 101 from one of the devices shown in FIG. 1. Further, each of the actors (e.g., users, coaches, teachers, parents, athletes/patients, observers, home medical practitioners, and away medical practitioners) may be required to undergo a registration process with the EMR utility 103, as described herein, in order to be provided with a user account to access the EMRs in the EMR database 105 through the EMR utility 103. Each user account is configured with attributes unique to the user or class of user, as further described herein.

In an exemplary scenario, a coach or trainer of a sports team may wish to register all members of the team with the system. The coach or athletic trainer accesses the EMR utility to create a profile for herself and her team. The EMR utility may require the coach to undergo training hosted by the EMR utility, prior to generating a user account. For example, the EMR utility may require the coach to watch hosted videos and/or complete a quiz or test to assess the coach's or athletic trainer's familiarity with the EMR utility, as well as basic knowledge relating to common sports injuries and associated treatment and identification techniques.

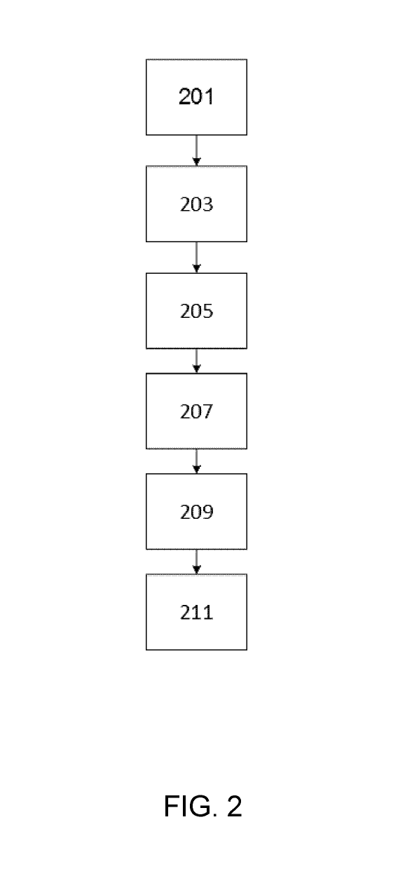

Referring now to FIG. 2, a method is shown for configuring a coach/trainer user account in the EMR utility. The coach accesses the EMR utility from her device and indicates that she would like to configure a new ‘coach/trainer’ user account, at block 201. The EMR utility then prompts the coach or trainer to provide her identifying information, such as, for example, her email address, telephone number, name and team affiliation, at block 203. If the coach was required to undergo the pre-registration training described above, the coach/trainer will also enter, at block 205, a certification number issued by the EMR utility upon completion of the course. The coach then selects a user identity, such as, for example an ID number or code at block 207, and a PIN or password at block 209. In embodiments, the ID would have been generated upon completion of the aforementioned training. Upon entering all the requisite information, a “coach” profile is generated for the coach, at block 211. The profile will thereafter be associated with the coach's ID, or user identifier.

Once the coach has created a user account for herself, she may begin adding team members to the system by, for example, entering in the EMR utility the anonymous identifier, or token, and information for players the coach wishes to enter into the system. Similarly, a teacher may wish to create a roster of athletes comprising students from the teacher's class. The EMR utility may charge a fee for each team or player on the team to be entered into the system. After the EMR utility confirms that the coach has made the required payment, or entered the appropriate number of team members to enroll, the EMR utility generates and displays to the coach at least one confirmation code to be used by the team members when generating athlete profiles in the system. The coach may disseminate each of the confirmation codes to the athletes, or the EMR utility may notify the athletes via email or other suitable communication that confirmation codes are available. It will be appreciated, however, that the EMR utility can only disseminate the confirmation codes to athletes if the athletes' contact details are known to the EMR utility, for example, because the coach entered email addresses for each athlete before, during, or after causing the EMR utility to generate the confirmation codes.

The generation of an athlete's user profile involves two stages: (1) the athlete enters preliminary information from his device; and (2) upon the athlete presenting at his home medical practitioner, the home medical practitioner issues the athlete a token by which his EMR data will henceforth be accessed by most system users, as hereinafter described in greater detail.

In further embodiments, an administrator may instead issue the physical token for the coach or other distributor to distribute to each athlete, or the administrator may distribute confirmation codes to the coach or athletes. The token may include the confirmation code for the athlete. In still further embodiments, the code issued is the code identifier or embodiment of the athlete's token, so that all users may henceforth identify the athlete to the EMR utility by the identifier. Even after an athlete has been added to the EMR utility, the athlete's coach, trainer, or teacher, may not view or interact with the athlete's EMR unless the athlete has allowed the coach, trainer or teacher to do so. For example, the athlete may receive an email containing a query for permission upon completing registration. If the athlete replies to the query to allow access, the EMR utility will register the permission; otherwise, the coach, trainer or teacher will not have access to some or all data within the athlete's EMR.

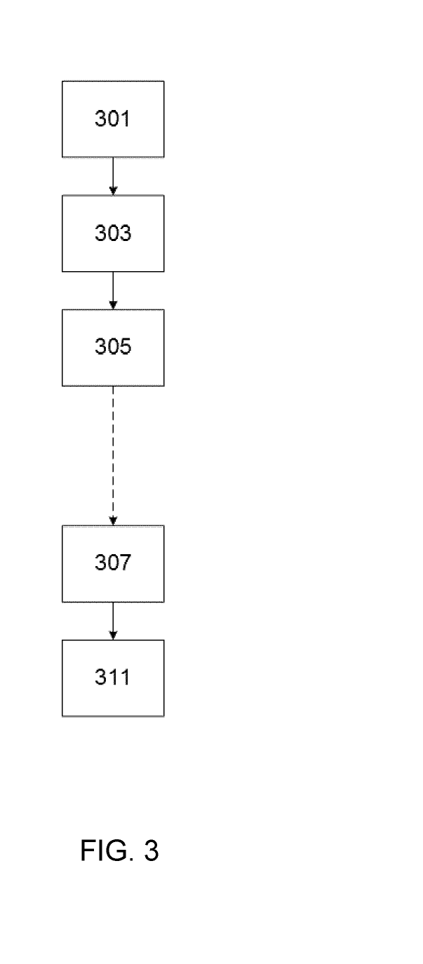

Referring now to FIG. 3, a method is illustrated for configuring an athlete's user account in the EMR utility. The athlete, having received his confirmation code or token, described above, accesses the EMR utility on his device and indicates that he wishes to configure a new ‘athlete’ account. At block 301, the EMR prompts the athlete to enter identifying information, such as, for example, his name, email address, telephone number, date of birth and the confirmation code. At block 303, the EMR prompts the athlete for further information, such as, for example, further demographic information. Once the athlete has provided the required information, the EMR utility provides the athlete with an appointment code and prompts the athlete to attend at the athlete's home medical practitioner for an in-person consultation, at block 305.

The EMR database stores all relevant patient medical record data, and identifies the stored data by the unique identifier of each patient who owns the data. The EMR database may further associate the token to the anonymous identifier.

The athlete presents himself at his home medical practitioner for an initial assessment, including baseline testing to assess baseline parameters for the patient. The athlete discloses his appointment code or presents his token to a staff member at his home medical practitioner. At block 307, the staff member enters the appointment code to call the athlete's information entered above at blocks 301 to 305. At block 307, if the athlete does not already possess a token, the staff member then issues a token to the athlete and identifies the token to the EMR utility. The EMR utility causes the EMR database to henceforth associate the token with the athlete's information and EMR data. In aspects, the token is discernible from a physical tag wearable or attachable to the athlete or his equipment. The tag may display an alphanumeric identification code, a PIN code, a UPC, a QR code, RFID tag or other electronic swipe technology corresponding to the athlete. Further, instead of issuing a tag to the athlete, the staff member could acquire a biometric reading from the athlete, such as, for example, a fingerprint or retinal scan which could serve as the athlete's token. Once the athlete has been associated to the token, the athlete's data may be shareable with other healthcare providers with access to the EMR server.

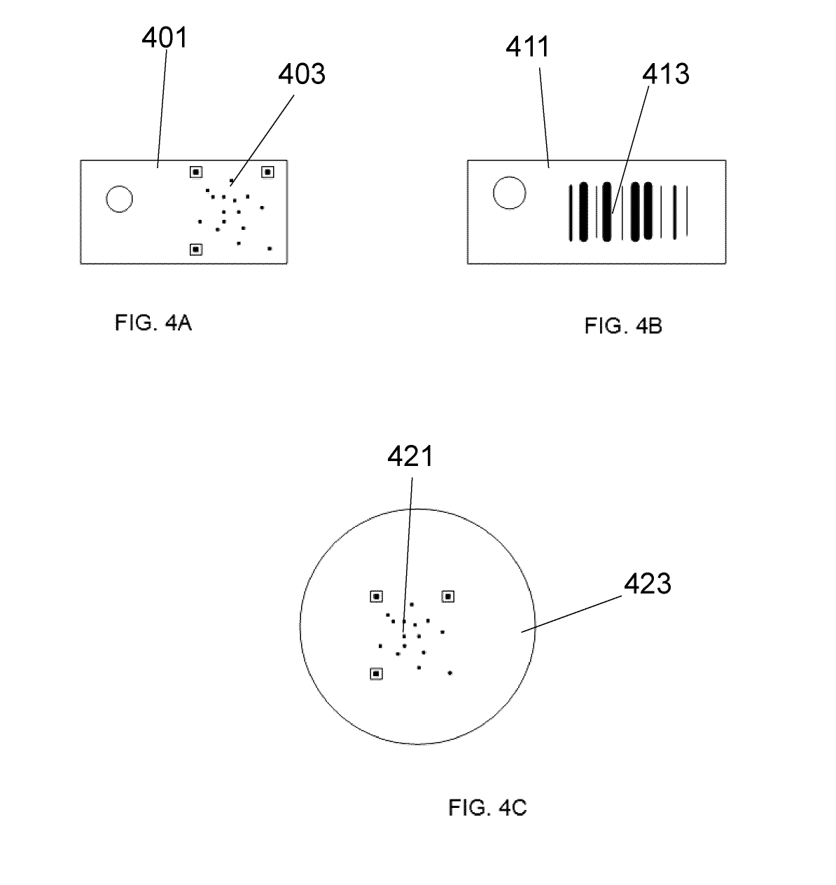

All tokens are anonymous, such that a third party, without further information about a given athlete, would not be able to associate the athlete with the athlete's token. The token is preferably further anonymous, such that no information concerning the athlete would be discernible from the manner in which the token is constituted. For example, the token would be further anonymous if a person having knowledge of the constituent elements of the token would not be able to discern the athlete's name, gender or age or other identifying details. At block 309, once the staff member has confirmed the information to the EMR utility, the EMR utility saves the athlete's user profile to the EMR database. The token issued to the athlete may be embodied by one or more of the following display surfaces or physical tags: a bag tag, helmet sticker, keychain tag, wristband, vest, or other suitable display surface for displaying identifying information, such as, for example, a QR code, UPC, alphanumeric code, or other visual or signal emitting cue. Further, as described above, the athlete's biometric features could serve as the athlete's token. Exemplary token configurations are shown in FIGS. 4A to 4C. FIG. 4A illustrates a bag tag 401 displaying a QR code 403, FIG. 4B illustrates a bag tag 411 displaying a UPC 413, and FIG. 4C illustrates a helmet sticker 421 displaying a QR code 423. It will be appreciated that the displayed codes illustrated in FIGS. 4A to 4C are visual codifications of underlying information, such as, for example, a numeric identifier for the athlete. In addition to the visual codes shown in FIGS. 4A to 4C, the display surfaces may further display an alphanumeric code alongside the QR codes or UPCs described.

Where the user devices are adapted to scan the tag to discern the athlete's token, the athlete's tag is scanned in order to identify the athlete to the EMR utility. For example, a user device may be configured to scan QR or UPC codes, receive RFID signals, read swipe cards, or read or scan biometric attributes of an athlete. Alternatively, the athlete's token may be associated with an alphanumeric identifier, so that a user may enter the identifier on the user device to identify the athlete to the EMR utility.

The present systems and methods may be enhanced by establishing initial, or baseline, data for the various athletes. Continuing with the exemplary scenario of a coach wishing to enroll her team in the system, future reporting of athlete injuries or incidents posing potential risks to athletes' health may be compared to baseline data for athletes taken pre-season, preferably upon, or immediately following, generation of athletes' user profiles.

Upon presenting at his home medical practitioner, and after generation of the athlete's user profile, the medical practitioner accesses the EMR utility to enter baseline data for the athlete. The medical practitioner may access the athlete's profile by scanning or otherwise entering the code relating to the athlete's token. In embodiments, home medical practitioners, who may have a very high degree of access to the patient's EMR, may also search for the athlete's user profile by name rather than by token.

In embodiments, the EMR utility, as it presents to the home medical practitioner, comprises a baseline module which prompts the medical practitioner to enter baseline data for the athlete. Baseline data may comprise, for example, factors relating to a patient's sensitivity to pain, typical sleep habits, reaction times, memory, concentration, balance, strength, neurocognitive test scores, visual tracking and processing abilities, delayed memory recall, as well as other physical and mental ability assessment scores. These and other factors are determined by the healthcare practitioner in consultation with the athlete. Once entered, the data is added to the athlete's profile in the EMR database for future use. Healthcare practitioners may add further information as they require, including by annotating EMR data.

As used herein, the terms medical provider, medical practitioner, healthcare provider and healthcare practitioner are used interchangeably and should be understood as encompassing individual healthcare practitioners, such as, for example, doctors, chiropractors, physical, occupational, and athletic therapists, nurses, and other clinical staff, as well as the firms or practices under which individual healthcare practitioners practise. In embodiments, the EMR utility is configured to generate user profiles for individuals with a given practice, as well as for the practice itself. The EMR utility generates user profiles by undergoing methods that are analogous to the previously described profile generation methods for athletes and coaches. Further, the EMR utility may be configured to distinguish between home medical practitioners and away medical practitioners, as well as various individual practitioners within a practice. For example, an away medical practitioner may not be able to search or access the EMR database by athlete name, but must instead search the EMR database based on an athlete's token when an athlete visits the away medical practitioner. In embodiments, only those healthcare practitioners meeting the standards of the EMR database administrator may enroll to access the EMR utility and database.

Further, other user types and classes may enroll with the EMR utility, as previously described. For example, athletes' parents or spectators may be provided with various access rights to the EMR database. Similarly, spectators who witness an injury may report the injury to the EMR database through a reporting portal in the EMR utility, or by creating a spectator profile using analogous methods to those described herein with respect to other actors or users.

Once the various users have obtained profiles on the system, they may access the EMR utility, which will present interfaces on the users' devices for interacting with the system, as hereinafter described.

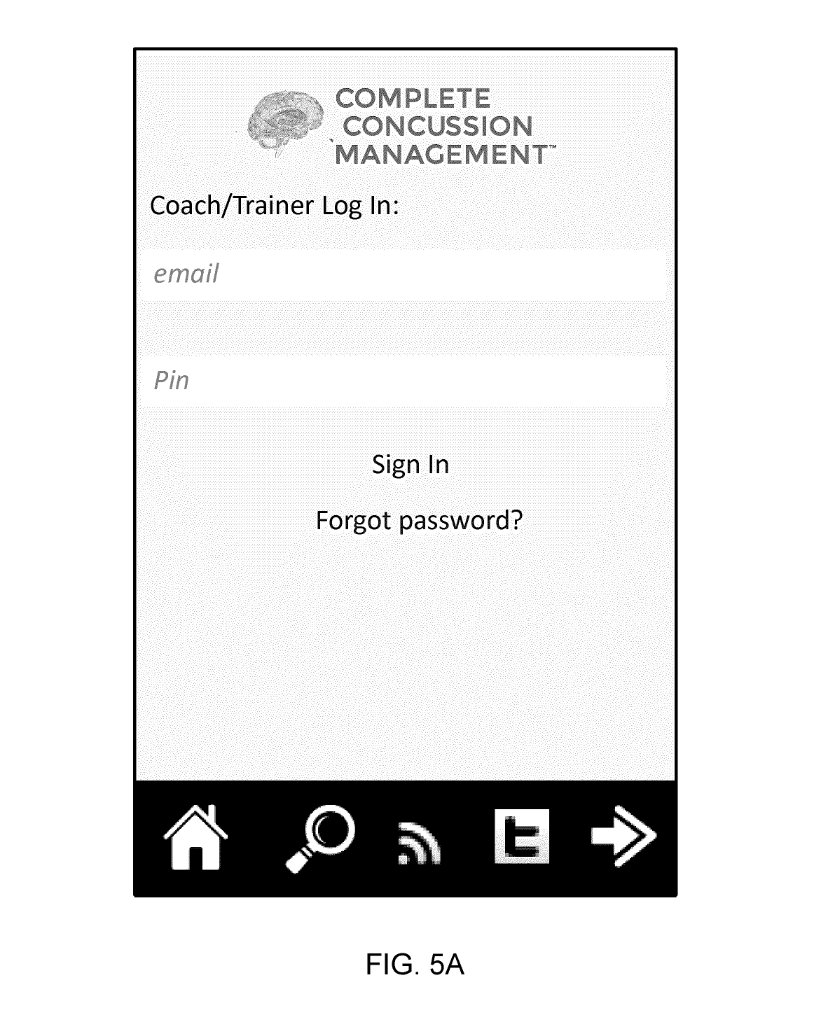

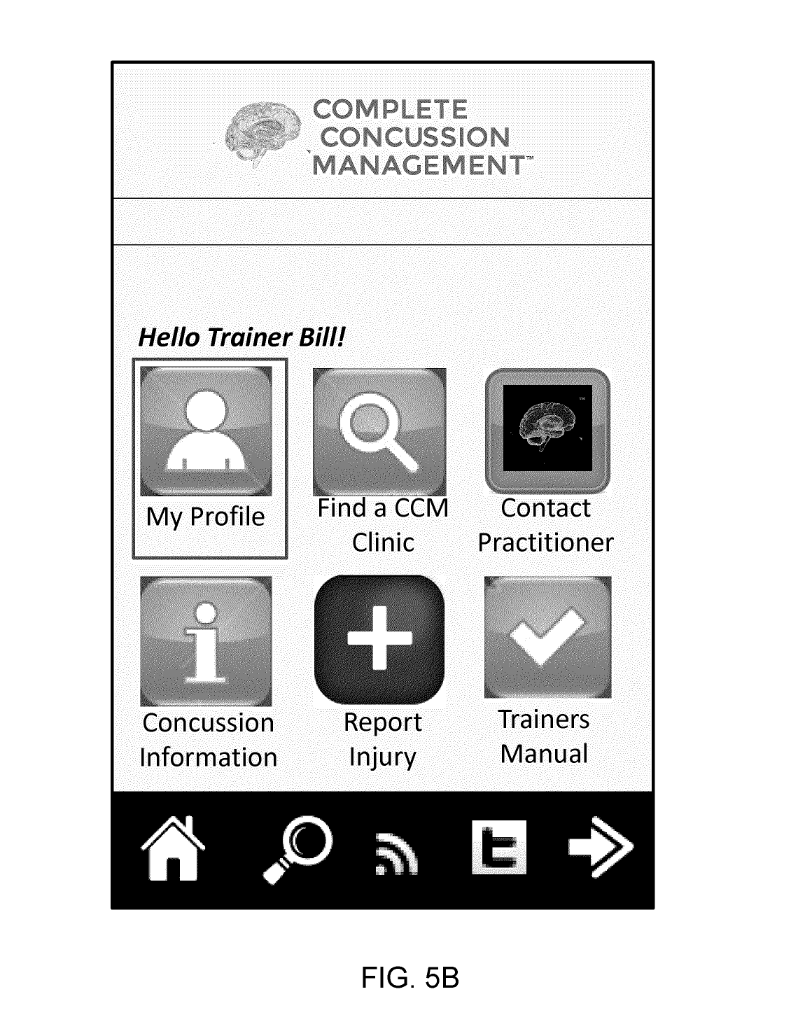

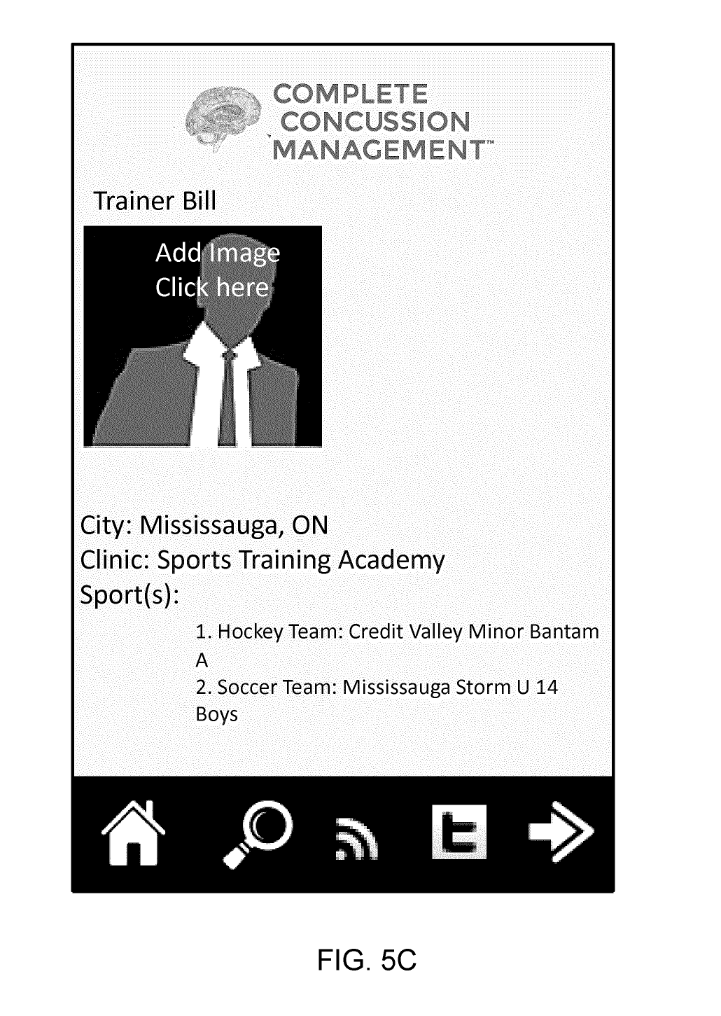

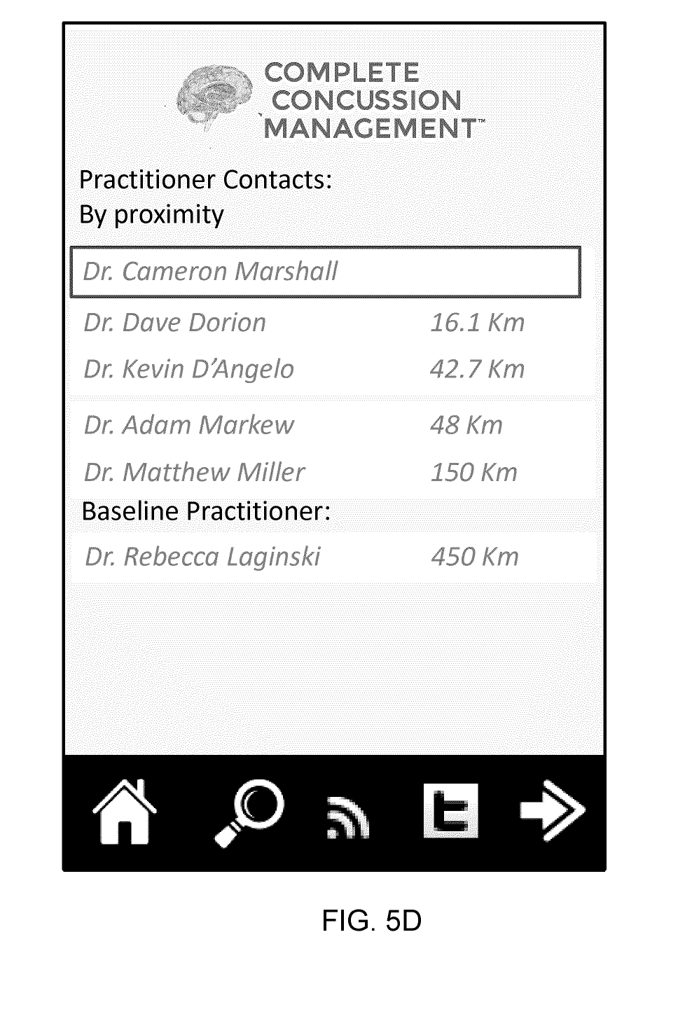

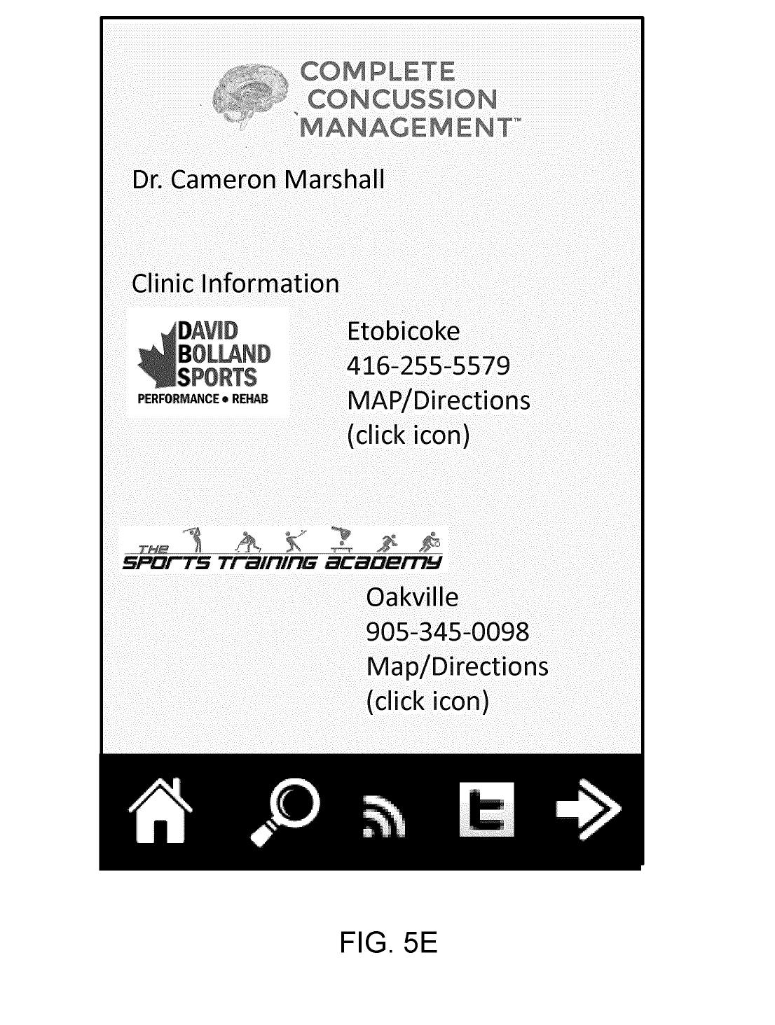

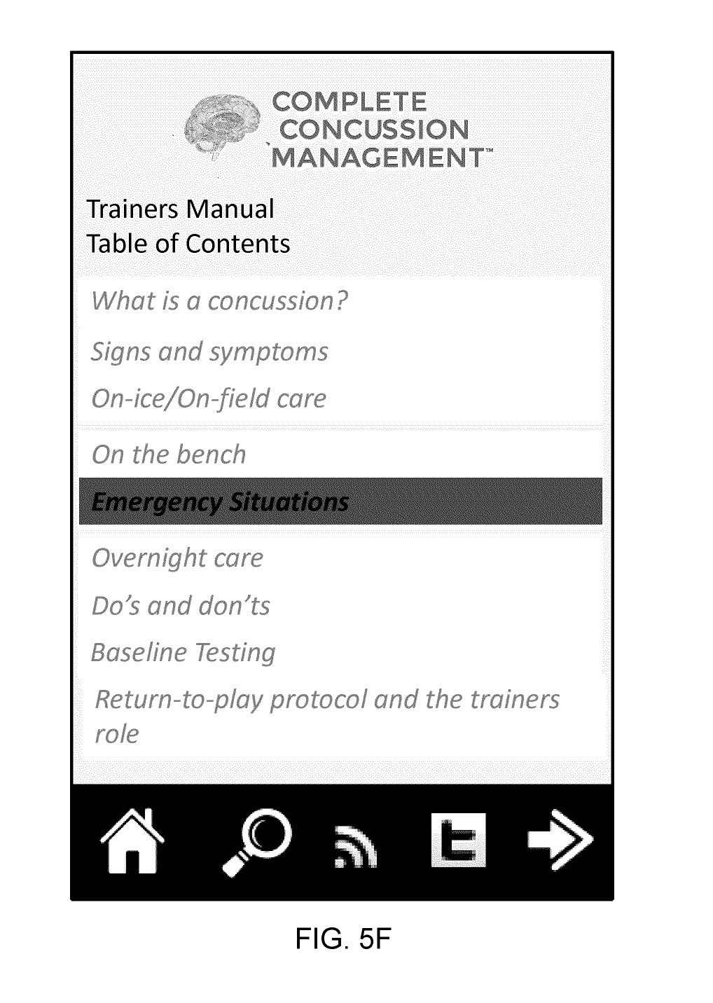

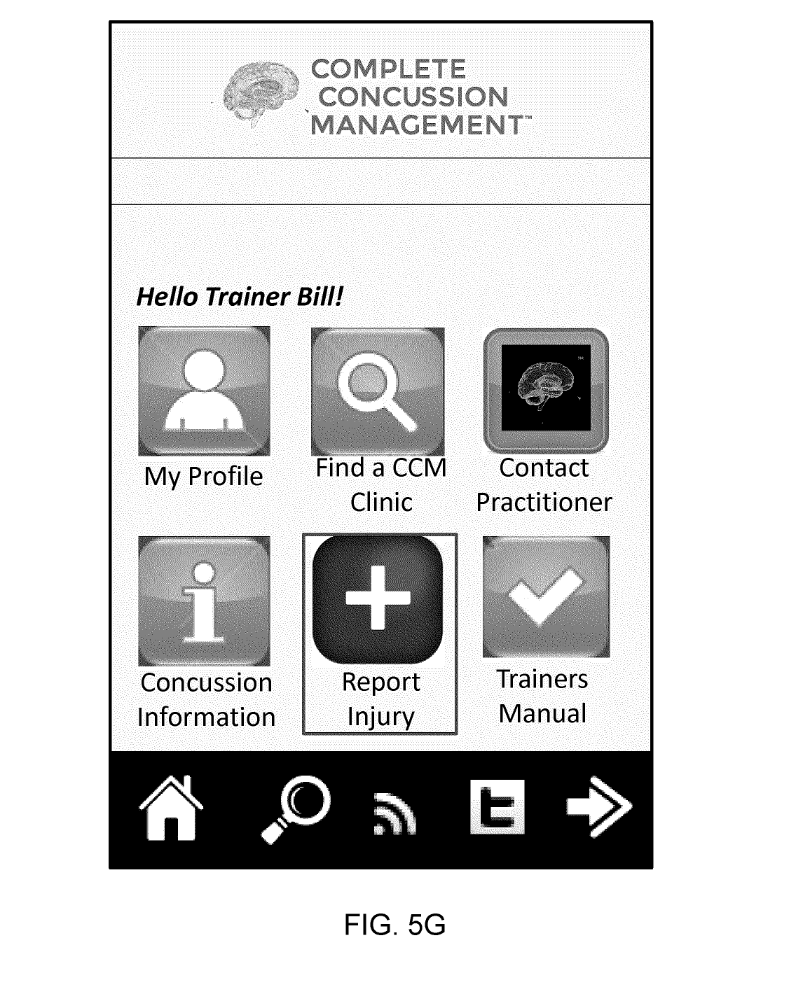

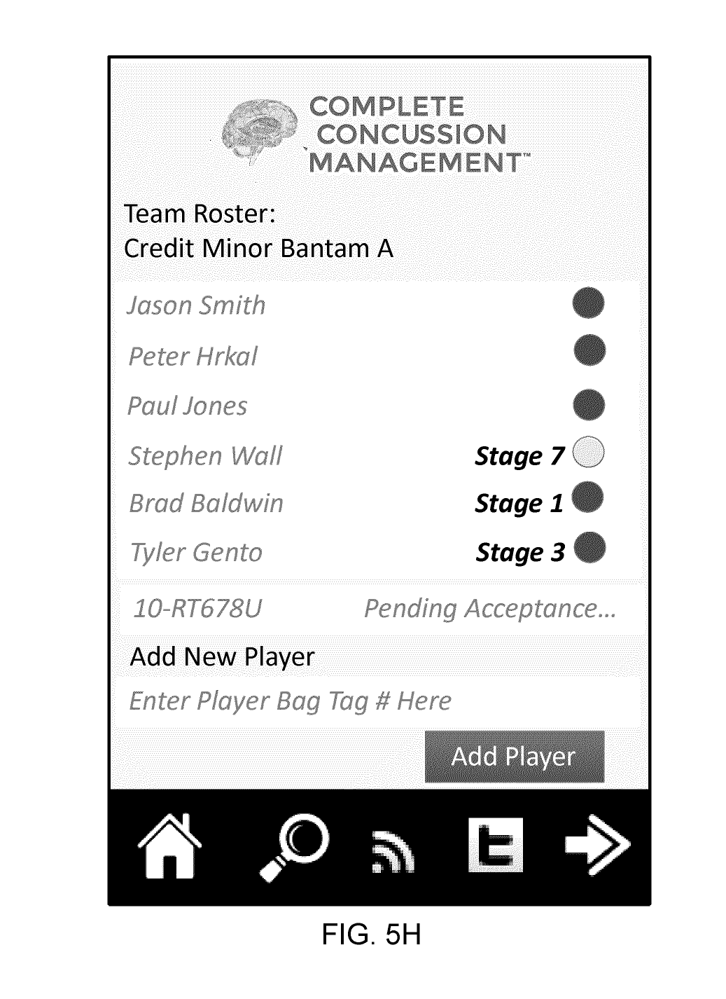

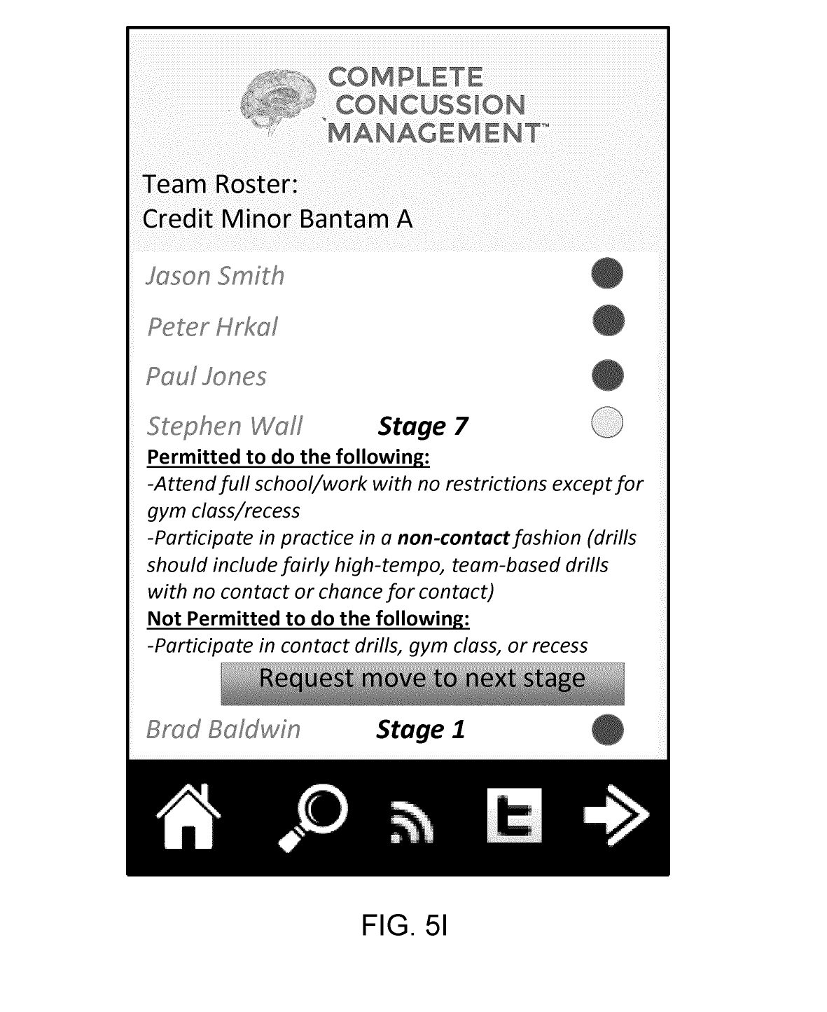

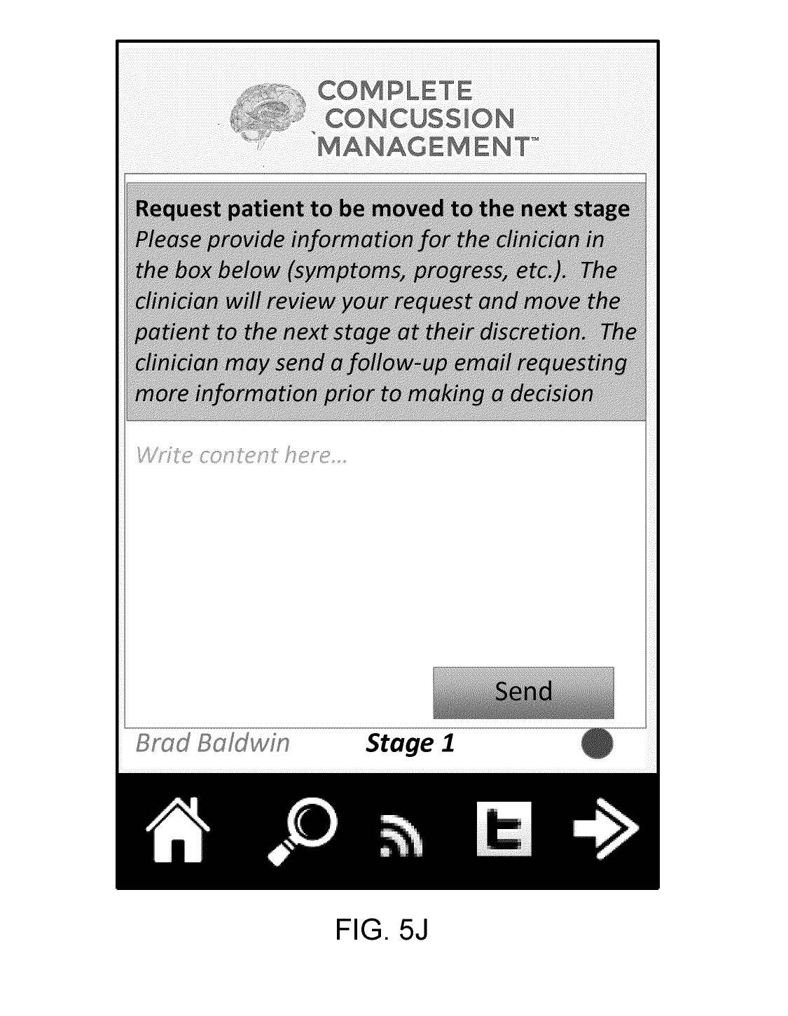

FIGS. 5A to 5G show embodiments of a coach- or trainer-facing interface enabling the coach or trainer to interact with the EMR utility. As shown in FIG. 5A, the interface provides a login page for the coach or trainer to log into the system by entering the login information, previously described, for her profile. As shown in FIG. 5B, once the coach has entered her login information, the interface displays a welcome page with menu icons and a welcome message. The interface may further display banner advertisements from relevant sponsors. Menu icons may comprise, for example, a coach profile icon, nearby medical practitioners with access to the system, concussion or other health related information, injury reporting and help icons. Selecting an icon causes the EMR utility to display a new page for that icon, such as, for example, a profile page for the coach or trainer, as shown in FIG. 5C. In embodiments, the coach or trainer may edit one or more fields in the profile page.

Selecting the “Find a CCMI Clinic” icon, shown in FIG. 5B, for example, causes the EMR utility to display a list of medical practitioners with profiles in the system located in the vicinity of the coach or trainer, as shown in FIG. 5D, or in a map format using the current location of the coach or trainer to display all medical practitioner locations within the immediate vicinity based, for example, on proximity or travel time. It will be appreciated that, for various medical conditions, time and proximity may be vital to enabling early diagnosis and treatment. In embodiments, the EMR utility acquires current localisation for a user based on localisation data obtained from the user's device, such as where the user accesses the EMR utility from a device having GPS or Wi-Fi localisation devices, and where the device communicates localisation data to the EMR utility. The EMR utility compares the device localisation data with localisation data from the user profiles of the participating medical practitioners and generates a list, or map (depending on user preference), of nearby medical practitioners for presentation to the user, as shown in FIG. 5D. The EMR utility may automatically display the list in order of proximity if an injury report is submitted for higher risk or urgent event, such as, for example, if the athlete is indicated as suffering severe blood loss.

In embodiments, the list or map of nearby medical practitioners is interactive, so that a user may select an icon or other representation of a listed medical practitioner to obtain more information about the medical practitioner, as shown in FIG. 5E.

If the user clicks on the ‘Trainers Manual’ icon shown in FIG. 5B, the EMR utility causes the user's device to display a menu page, as shown in FIG. 5F, displaying headings for training topics. When the user clicks on any of the headings, the EMR utility will cause the device to display information relevant to the heading, such as for example, instruction or training videos, or text.

If the user clicks on the “Report Injury” icon, shown in FIG. 5G, the EMR utility will cause a reporting portal to be displayed on the user's device.

The user may access the reporting module by selecting the ‘Report Injury’ icon shown in FIG. 5B. The EMR utility will prompt the user to report an athlete's injury or relevant incident by completing relevant fields, such as, for example, time of incident, cause of incident, parties to incident, and other details relevant to assessing the incident, such as, for example, basic sideline assessment techniques consisting of one or more of: balance assessment, memory and concentration tests, orientation tests, orientation questions and visual tracking abilities. The coach-facing reporting module may be substantially replicated in the athlete/parent-facing interface, described below in greater detail. In embodiments, certain users are only provided with rights to contribute data, such as, for example, incident reports, to a patient's EMR, but not to receive any EMR data from the EMR database.

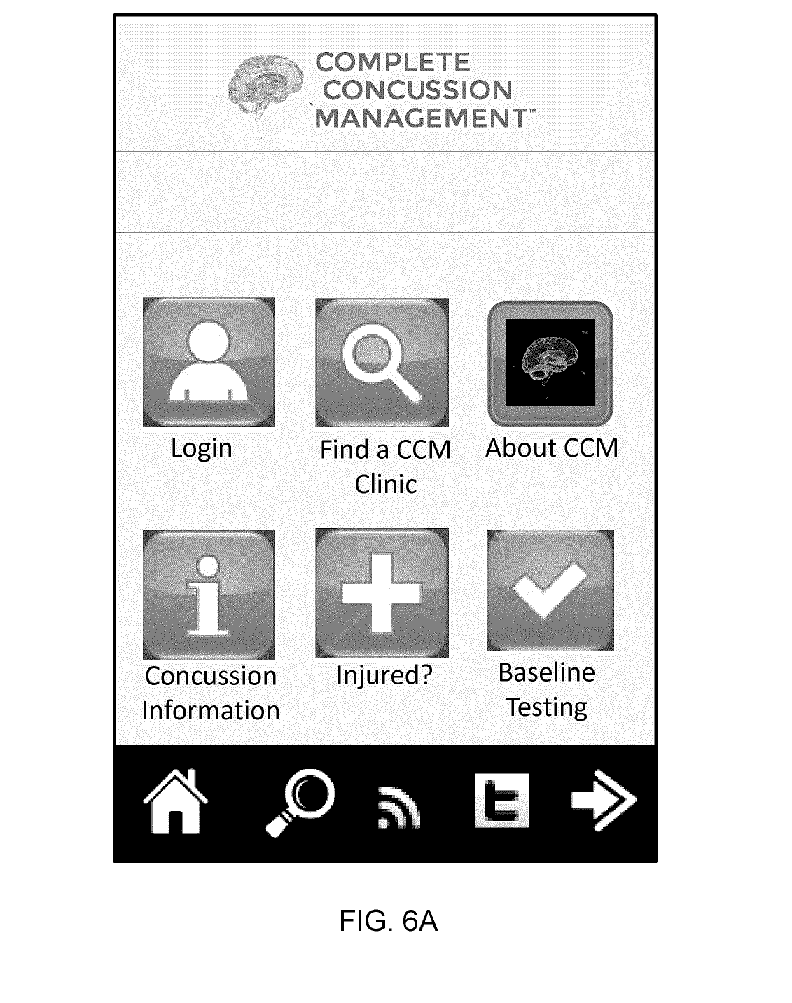

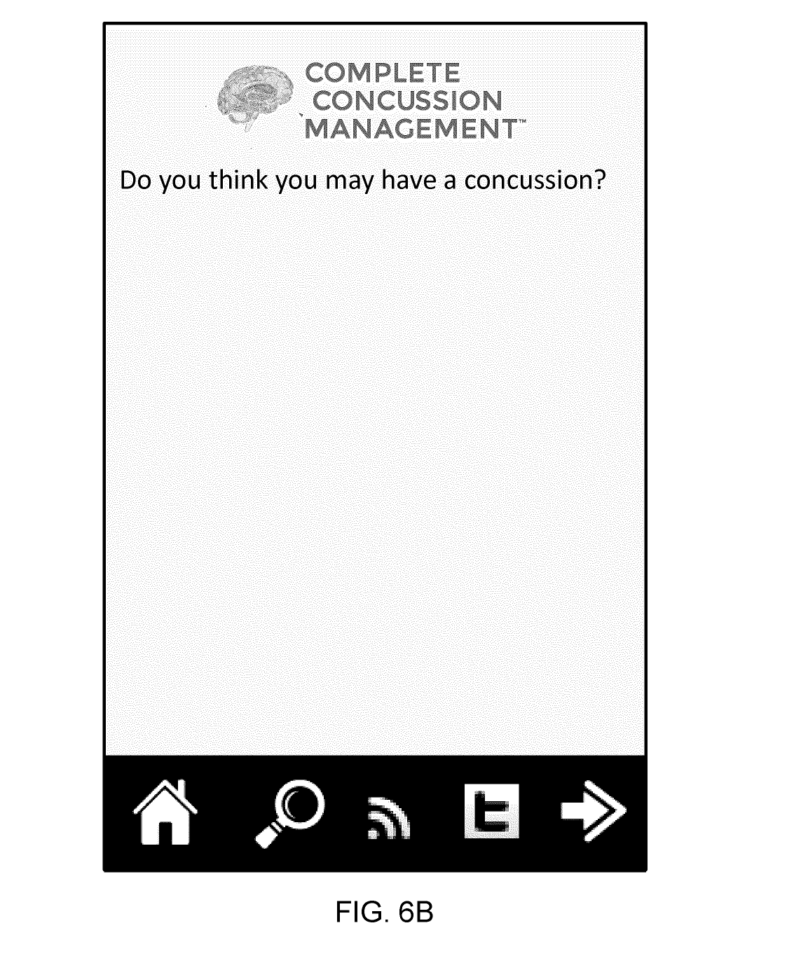

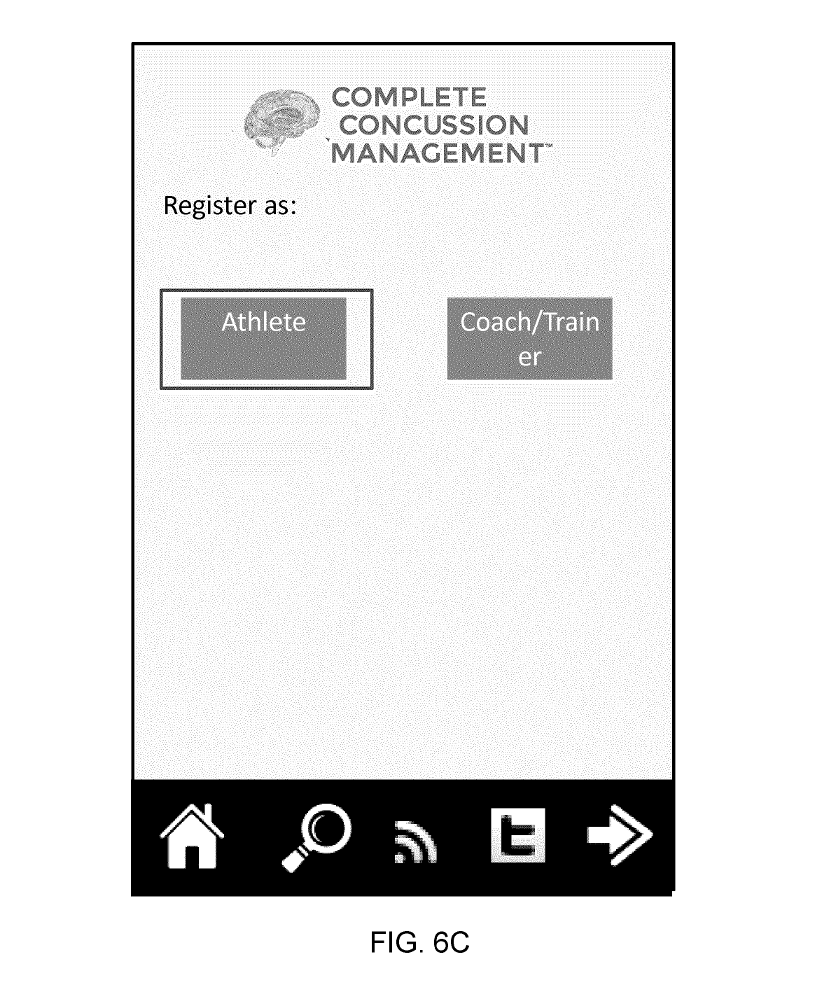

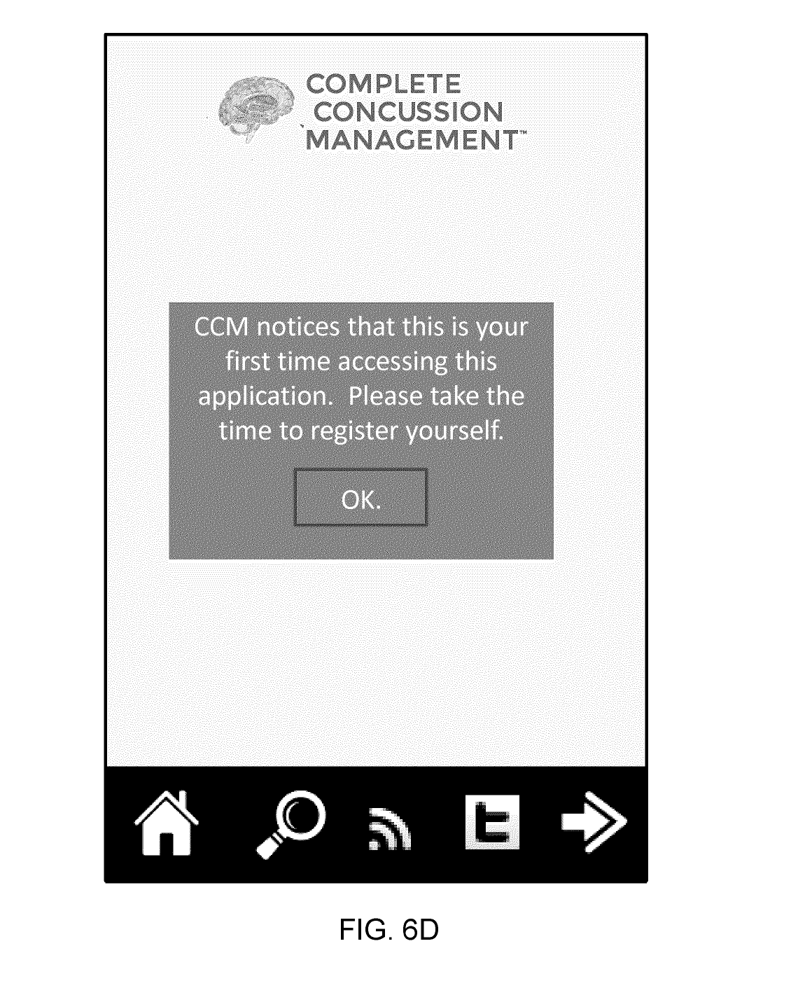

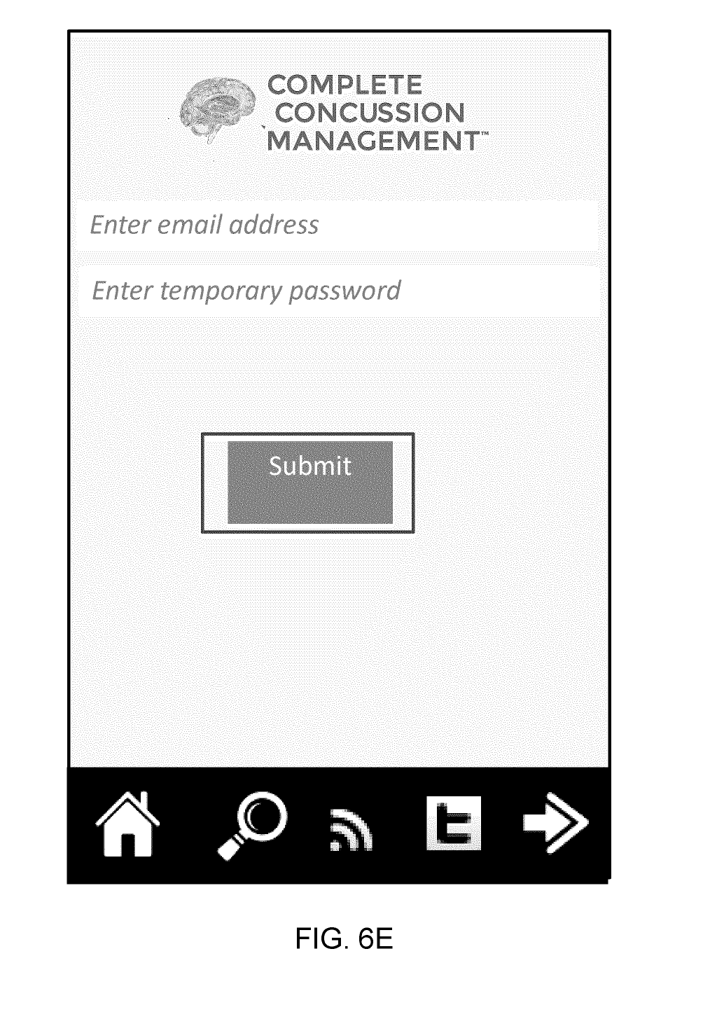

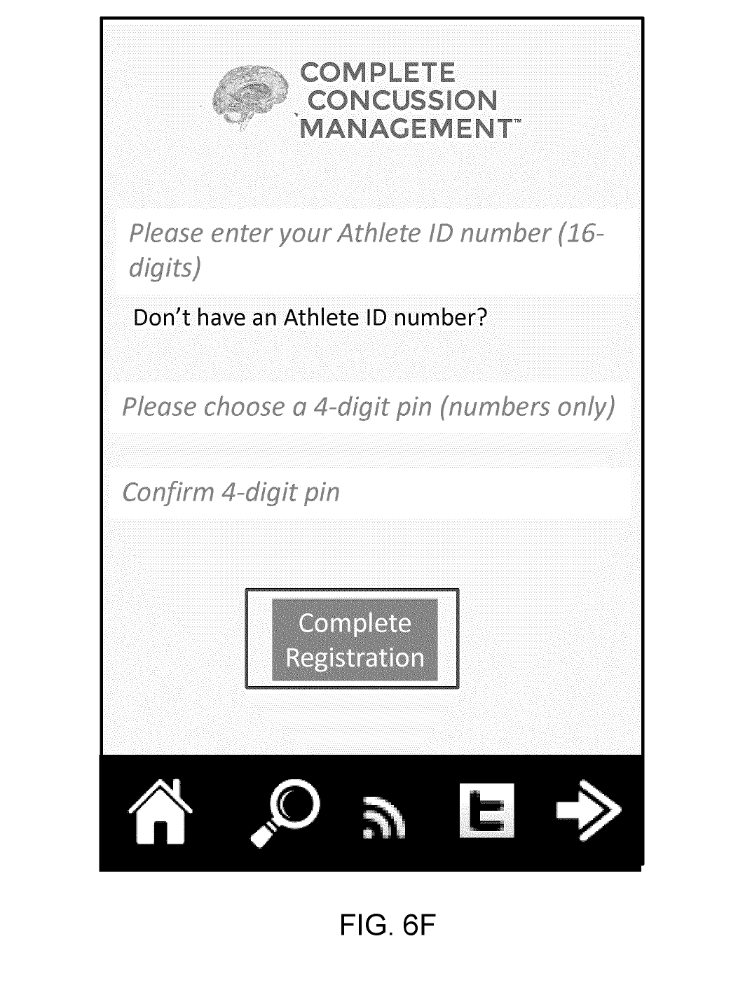

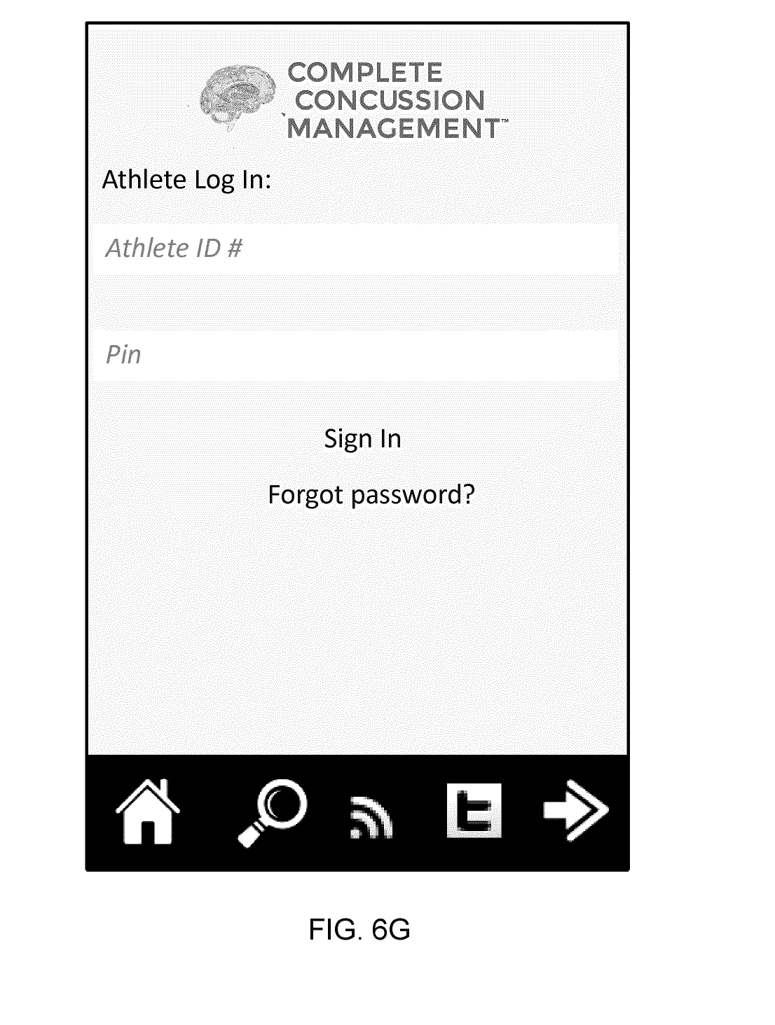

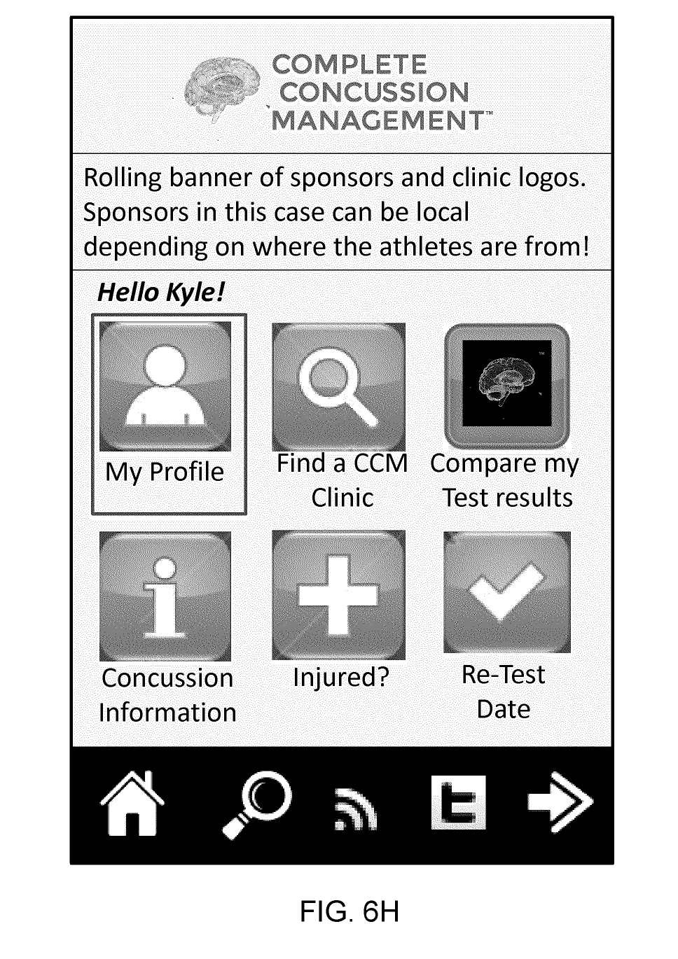

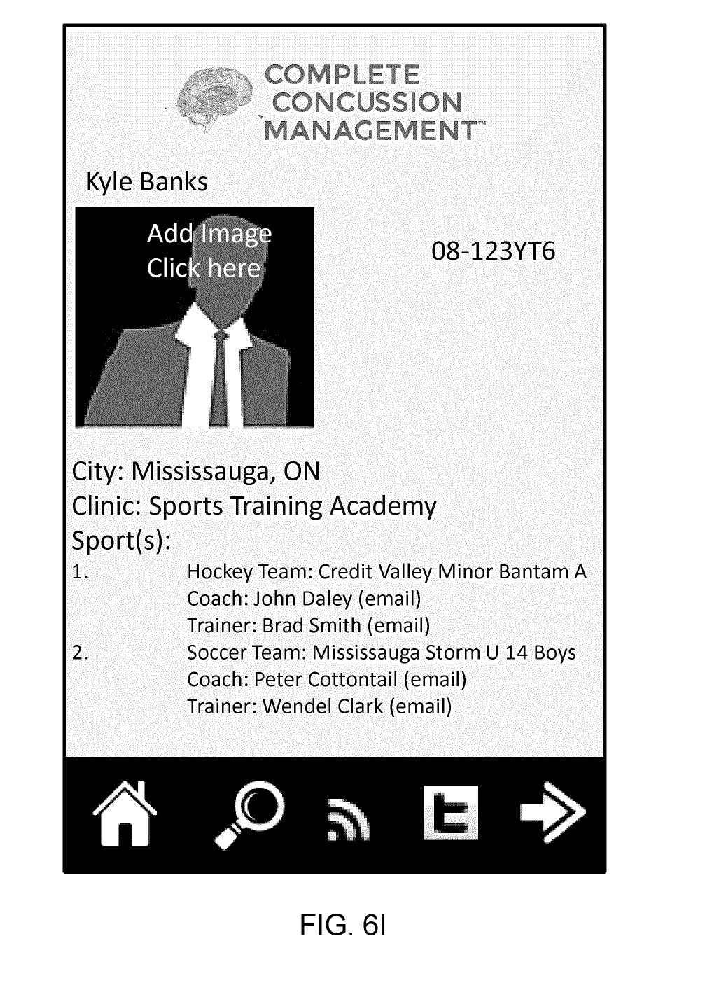

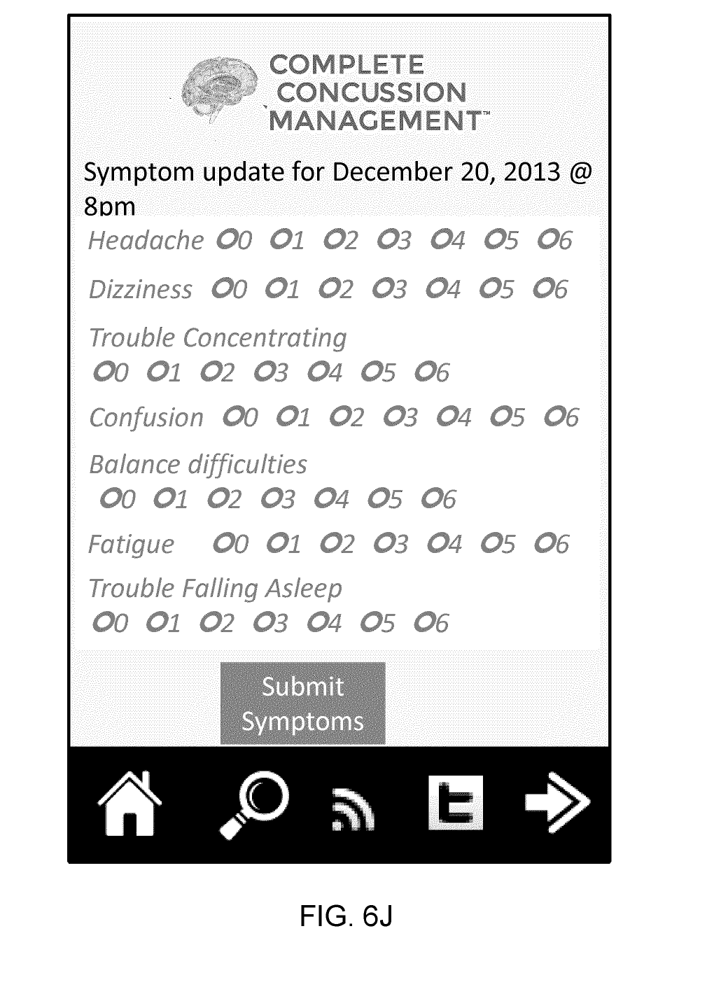

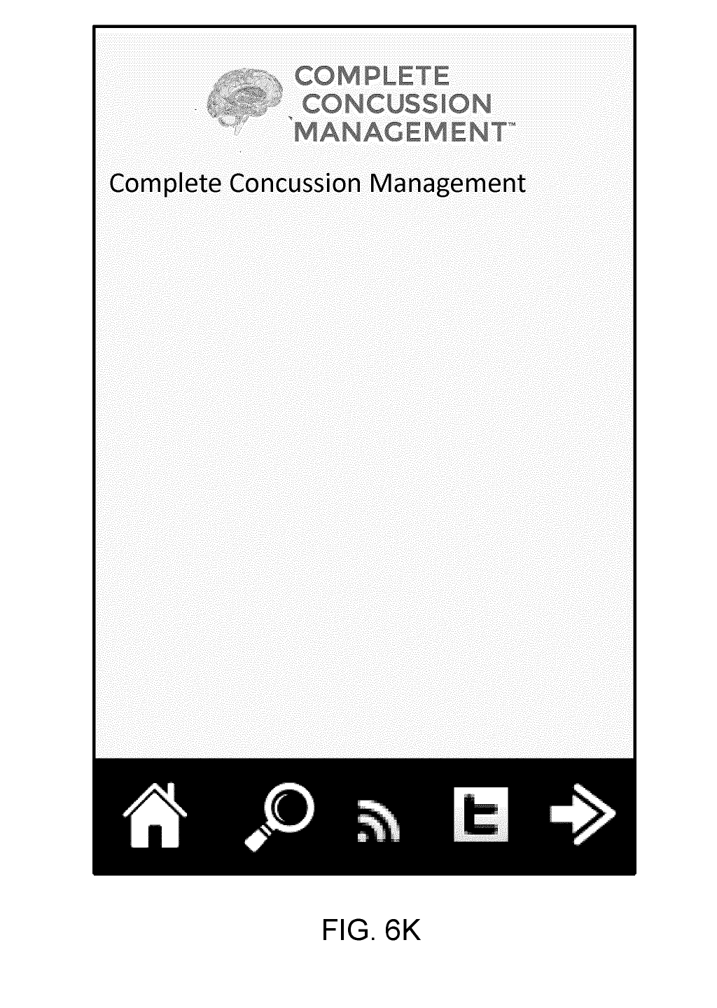

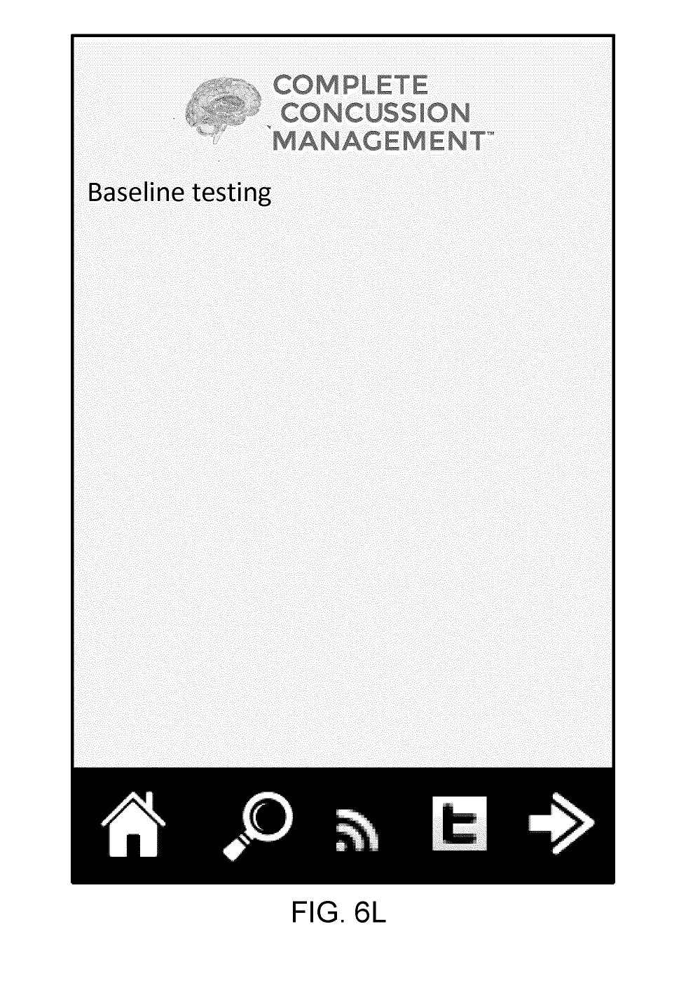

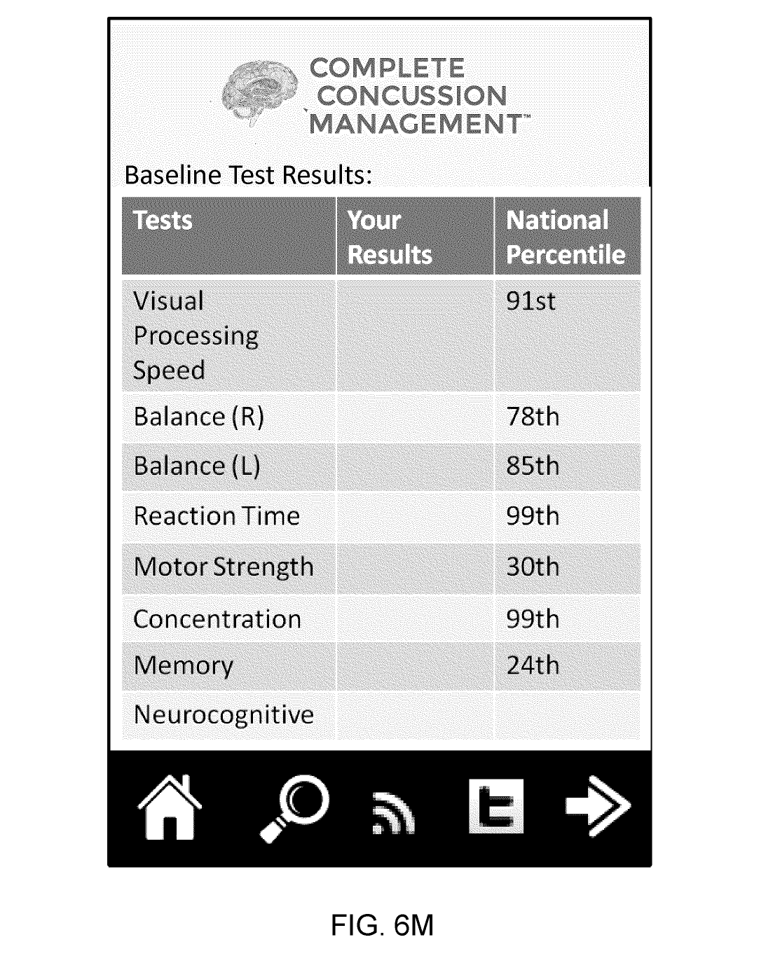

FIGS. 6A to 6M show embodiments of an athlete-facing interface enabling the athlete to interact with the EMR utility. In embodiments, a similar or identical interface may be displayed on the devices of the athlete's parents. It will be appreciated that enabling parent reporting allows parents of younger athletes to report injuries and monitor and report their children's progress during treatment. When the athlete accesses the EMR utility from his device, the EMR utility may display a welcome page, as shown in FIG. 6A. The welcome page may comprise interactive menu icons and a welcome message, as previously described with respect to the welcome page shown in FIG. 5B for the coach/trainer-facing EMR utility.

The welcome page may not necessarily be specific to any one of coaches, trainers, athletes or parents, and the page may even be displayed to the general public. The welcome page, shown in FIG. 6A, may comprise menu icons and a welcome message. The interface may further display banner advertisements from relevant sponsors. Menu icons may comprise, for example, a login profile icon, nearby medical practitioners with access to the system, concussion or other health related information, injury reporting, baseline testing and help icons, as well as an icon with information about the system (shown in FIG. 6A as ‘About CCM’). Selecting an icon causes the EMR utility to display a new page for that icon, such as, for example, a ‘Concussion’ page, as shown in FIG. 6B displaying information concerning concussions and other suitable injuries or conditions.

If the athlete clicks on the ‘Login’ icon, the EMR utility causes a selection page, as shown in FIG. 6C to be displayed on the user's device. If the user selects ‘Athlete’, the EMR utility may determine that the device has not previously registered with the system, for example, by detecting that the device does not have installed thereon a cookie from the EMR server. Once the athlete acknowledges that he has not previously logged in, for example, by selecting the ‘OK” icon, the EMR utility causes his device to display a new page, shown in FIG. 6E, where the athlete enters login information, such as, for example, an email address and temporary password. The EMR utility then causes the device to display a further login page, shown in FIG. 6F, where the athlete enters the identification code corresponding to his token and a further PIN or password, i.e., his user identity. If the athlete has already accessed the EMR from the device, the EMR utility may instead cause the device to display a login page, as shown in FIG. 6F, where the athlete accesses the restricted portions of the EMR utility by entering his token, as well his user identity.

Upon login, the EMR utility causes a personalised welcome page to be displayed, as shown in FIG. 6H. The personalised welcome page may comprise one or more of the icons from the general login page shown in FIG. 6A, as well as further icons representing features available only in restricted-access sub-utilities of the EMR utility. As shown in FIG. 6H, further icons may comprise, for example, an athlete profile icon, a compare test results icon, a reporting icon and a re-test date icon. If the athlete clicks on the profile icon, the EMR utility may cause the athlete's profile page to be displayed, as shown in FIG. 6I. The EMR obtains athlete-specific display information from the EMR database record corresponding to the athlete's token.

In embodiments, one or more fields in the athlete's profile page are configurable and/or interactive. For example, selecting a listed team of which the athlete is a member may cause the EMR utility to display information concerning the athlete's team, such as, for example, upcoming game schedules and a team roster. This information may have been provided to the EMR server by the athlete's coach or trainer in a corresponding coach-facing interface page (not shown).

Selecting the ‘Injured?’ icon in the personalised welcome page, shown in FIG. 6H, causes the EMR utility to display a reporting page, shown in FIG. 6J, on the athlete's device. The reporting page may comprise entry fields, such as, for example, text or radial inputs, which the user completes with information concerning an injury he has suffered and wishes to report. In embodiments, the reporting page 6J is replicated on the coach-facing EMR utility interface. When the user (e.g., athlete, coach, parent, teacher, trainer) completes and submits the form by, for example, selecting the ‘Submit Symptoms’ icon, the data entered in the form is transmitted to the EMR server for entry to the athlete's EMR records located in the EMR database. The medical practitioner-facing EMR utility may present the entry in order of date or other criteria, and further, for example, a subjective, objective, assessment, and plan (SOAP) note annotated to a patient's charts. The EMR server may prompt the patient to complete the reporting page shown in FIG. 6J on a daily or other periodic basis upon request from the patient's medical practitioner. Similarly, the patient's teacher, trainer, coach, parents, etc. may receive analogous requests from the EMR server, whether in the form of an email request or as a push notification on the user's device. Data entered in response to such requests are transmitted to the EMR server, which automatically uploads the data to the EMR database. The requests may further issue automatically from the EMR server once the EMR server receives a report from any user that a patient (i.e., the athlete) has suffered an injury.

In embodiments, users other than the medical practitioner are restricted from viewing some or all patient medical data from the patient's EMR, depending on the user's access rights to the EMR database. In further embodiments, patients and their parents may be provided with identical access to the patient's EMR.

Selecting the ‘Find a CCM Clinic’ icon, shown in FIGS. 6A and 6H causes the EMR utility to display a listing page of nearby medical practitioners with profiles in the system, as previously described with reference to FIG. 5D. In further embodiments, the user may instead search by another location from a list of all participating medical practitioners.

If the athlete clicks the ‘About CCM’ icon, shown in FIGS. 6A and 6H, the EMR utility will cause the user's device to display information concerning the system and its administration, as shown in FIG. 6K.

The baseline testing icon, shown in FIGS. 6A and 6H takes the athlete to a page, shown in FIG. 6L, displaying information concerning baseline testing and its benefits.

The ‘Compare my Test Results’ icon on the personalised welcome page, shown in FIG. 6H, takes the athlete to a page, shown in FIG. 6M displaying one or more of the athlete's baseline parameters in comparison with the athlete's peers. In embodiments, the display of the athlete's baseline parameters may be contingent on the athlete paying a fee.

In embodiments, any party reporting an incident concerning an athlete may enter the athlete's token into the reporting interface by, for example, entering the alphanumeric code shown on the athlete's bag tag or, by capturing an image of the code as displayed on the athlete's token display. For example, if the athlete has on his helmet a label displaying a QR code, the party reporting the incident may capture an image of the QR code and enter the image thereof into the reporting interface. In embodiments, the reporting party's device may comprise a QR code reading application for capturing the QR code. If the QR code comprises a link to access the EMR utility, capturing the reporting party's device may automatically access the EMR utility and, preferably, take the reporting party directly to the reporting interface.

When any user submits or requests information to the EMR server in conjunction with an anonymous token for a patient, the EMR server identifies relevant data according to the anonymous token.

Once an incident report has been generated and submitted as previously described, the EMR server may notify the reported athlete's medical practitioner via email or push notification on the medical practitioner's computing device. The medical practitioner may select whether to approve the report, either based on the information available in the report or following an in-person consultation at either the home, or away clinic, depending on where the reported athlete reports. If the report is approved, the incident data contained therein is added to the athlete's EMR on the EMR database. The EMR utility detects the new data and notifies the athlete's home medical practitioner (if the report has been approved by an “away” medical practitioner), as well as the athlete's other authorized participants, such as, for example, the athlete's trainer, teacher, coach. Notification may be email or other push notification to the various users' EMR sub-utilities. In further embodiments, the athlete's home medical practitioner and a local, or ‘away’ medical practitioner receive the notification, particularly in situations where the incident occurs in a region other than the region served by the athlete's home practitioner. In still further embodiments, the notification to the user, his parents, coach, and/or trainer may comprise information concerning assessment and treatment options, as well as care advice.

The medical practitioner, whether a home medical practitioner or an away medical practitioner, accesses the athlete's medical records through a medical practitioner sub-utility. The preferred distinction between the access afforded to home and away medical practitioners is that an away medical practitioner may only be able to access the athlete's medical records when the athlete presents at the away medical practitioner's site and provides the practitioner with his token, whereas the athlete's home medical practitioner may search for the athlete's medical records by name.

In a scenario, the athlete may have suffered a reported injury at a time or location such that it would be impractical to visit his home medical practitioner. If the athlete has suffered or potentially suffered a concussion, for example, he may wish to visit an away medical practitioner with access to the EMR server and database. Preferably, the away medical practitioner does not normally have or require access to the athlete's EMR. However, the away medical practitioner may view the athlete's EMR when the athlete presents his token. The away medical practitioner may then enter the identifying information associated with the token and thereby access some or all of the athlete's medical records in order to conduct an in-person assessment of the athlete. The information available to the away medical practitioner may include, for example, the athlete's baseline data.

Once an incident has been reported, the medical practitioner conducts a preliminary review of the incident report and determines whether the athlete should attend for an in-person examination. The medical practitioner indicates her decision in the medical practitioner-facing EMR sub-module interface. If the athlete is requested to attend an in-person examination, the athlete, his coach, trainer and/or parents may be notified on their respective devices by an email or push notification generated by the EMR utility. In aspects, the EMR utility enables medical practitioners to request additional information from the trainer, coach, athlete and/or other user, or provide instructions for the users on how to proceed to address the incident.

When the athlete reports to the medical practitioner for an in-person assessment, the athlete provides identifying information, preferably the token, depending on how the medical practitioner has rights to search the patient's EMRs, so that the medical practitioner may access the athlete's EMR. The medical practitioner enters the identifying information into a device presenting a medical practitioner-facing interface provided by the EMR utility. The EMR utility then retrieves the athlete's EMR and presents the data contained therein to the medical practitioner.

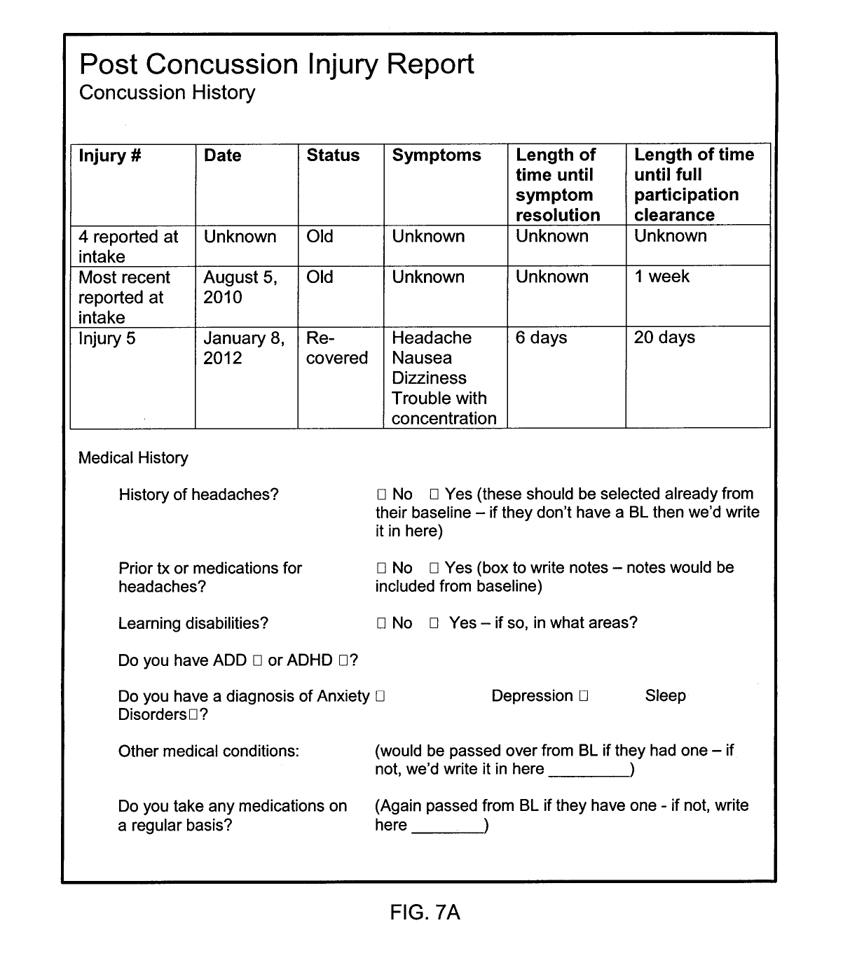

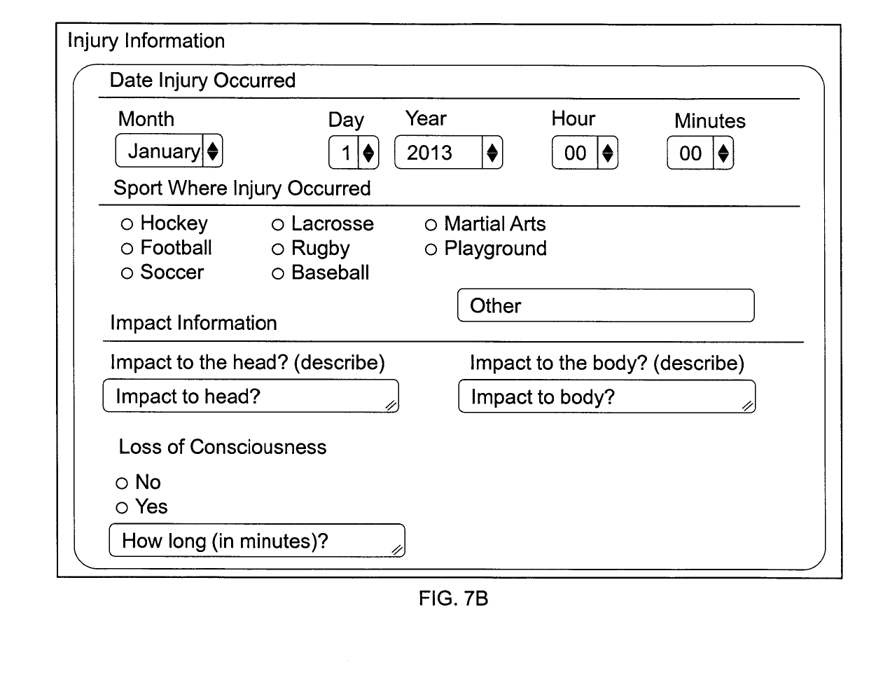

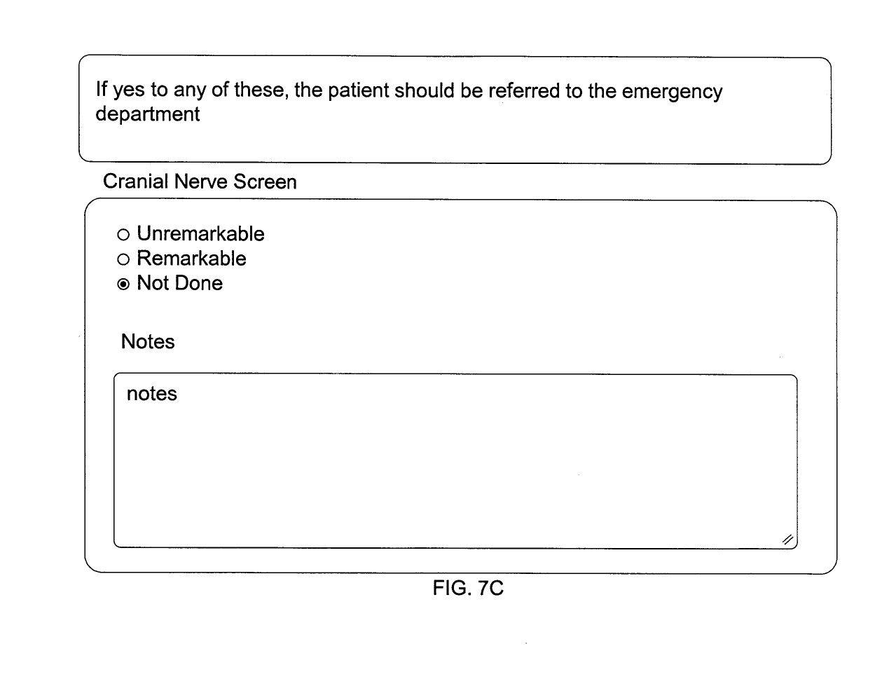

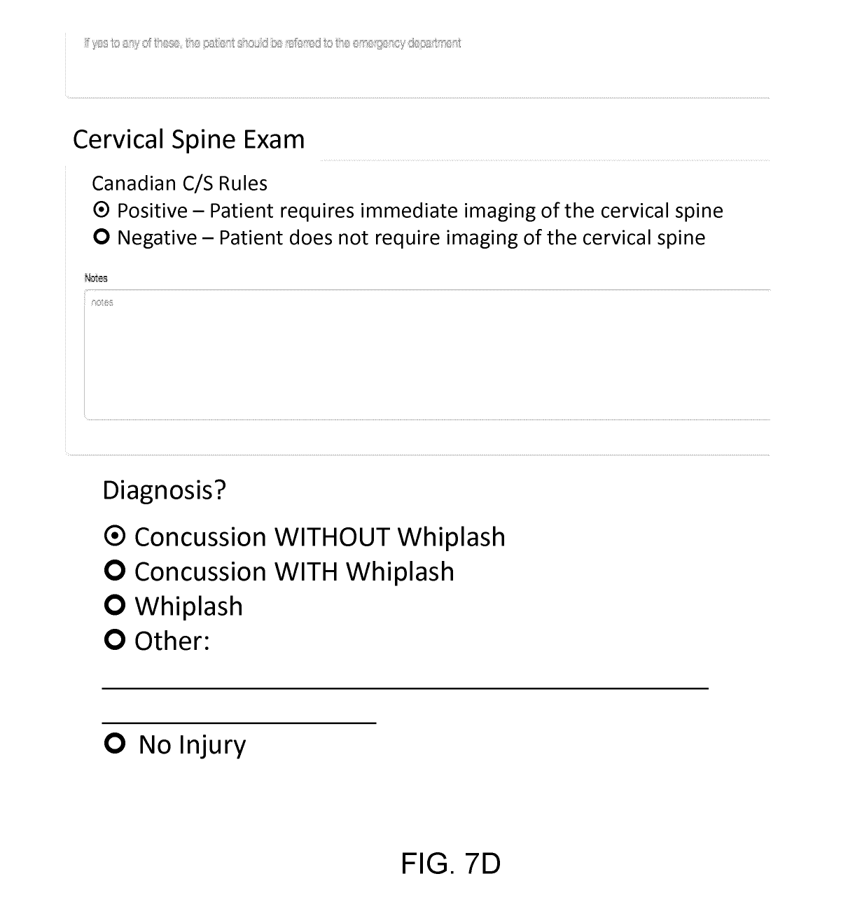

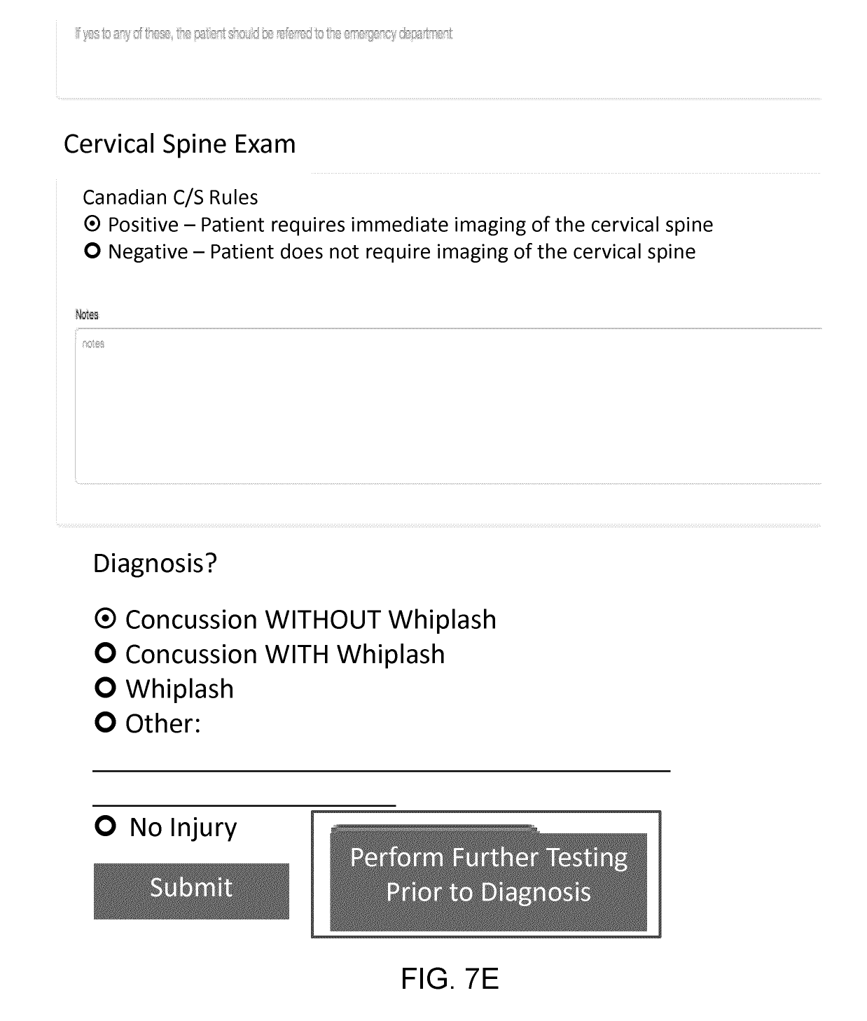

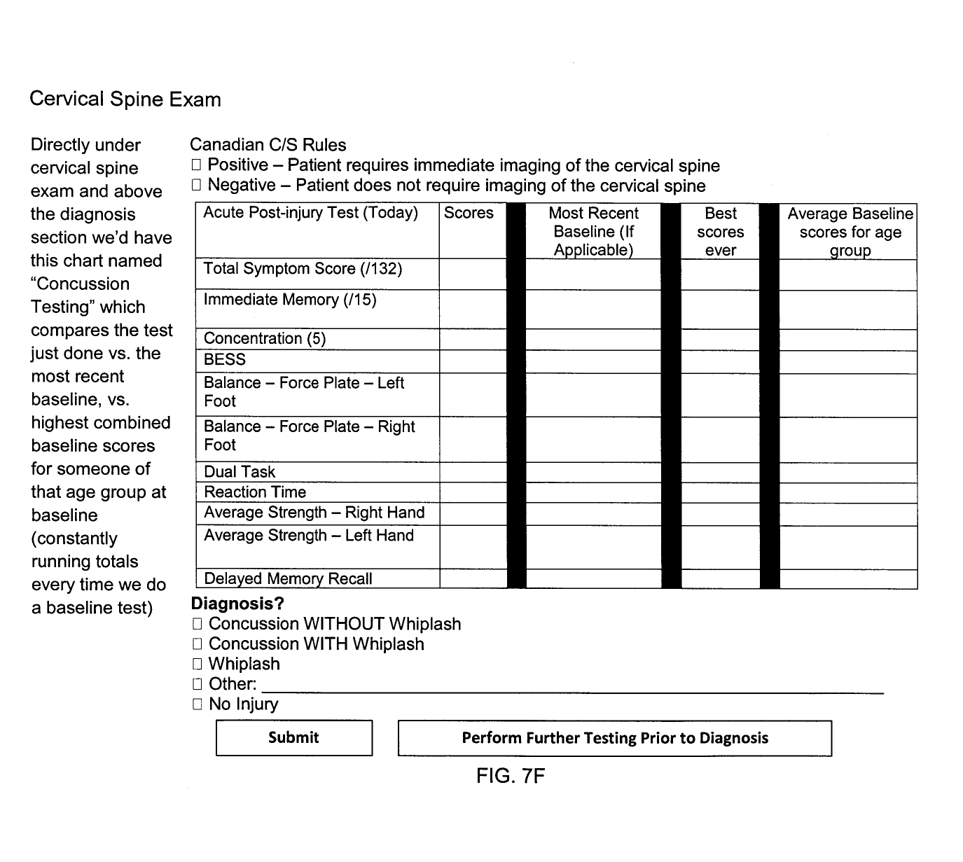

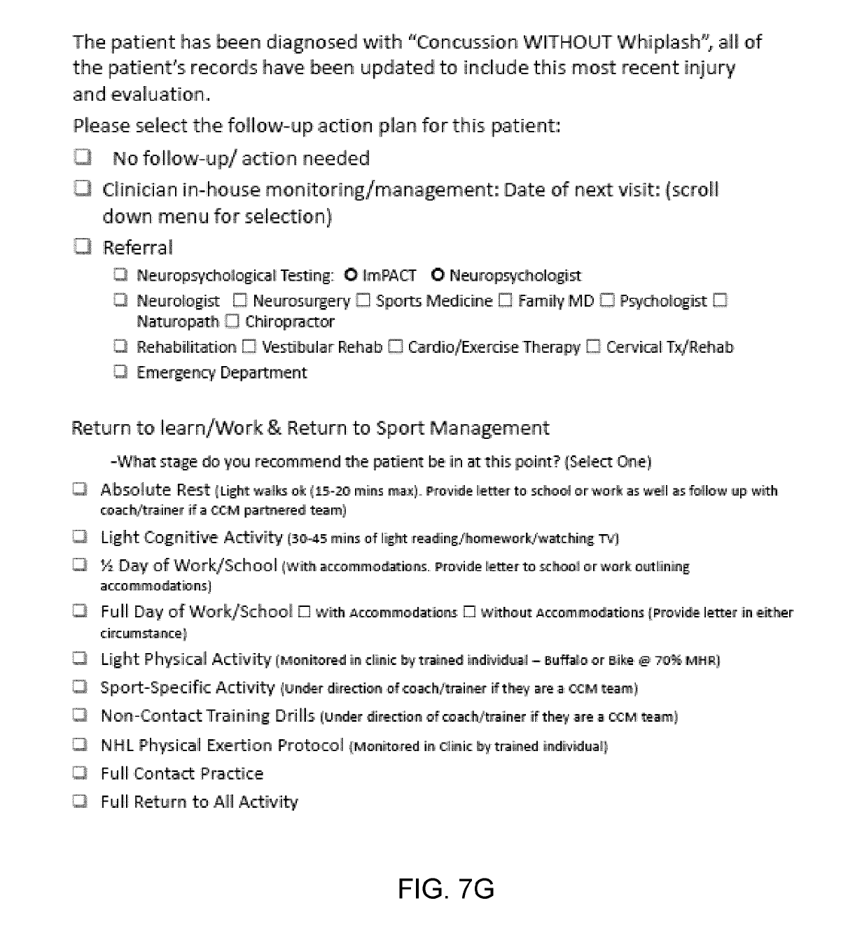

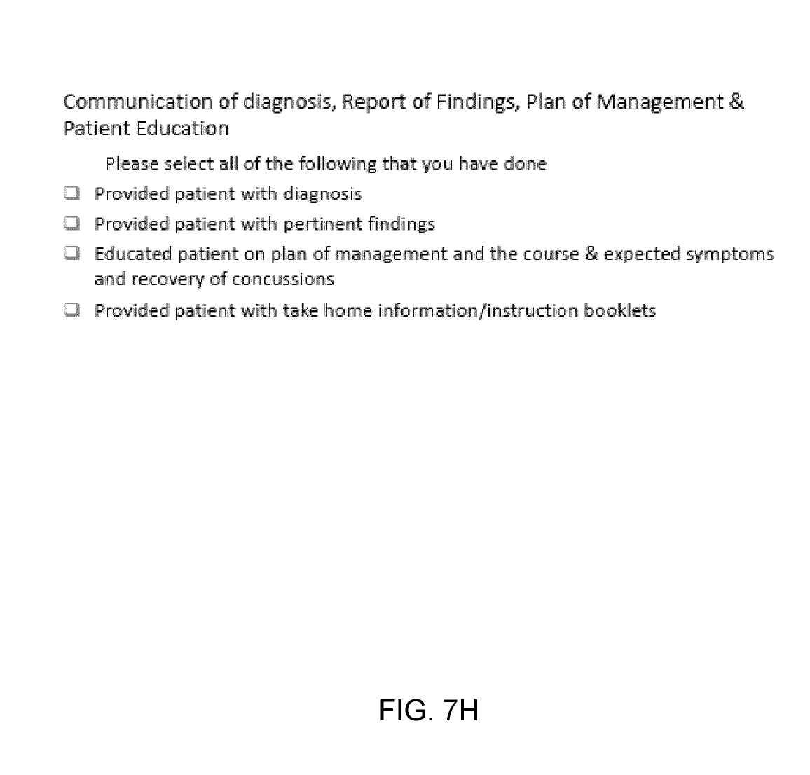

As shown in FIG. 7A, the medical practitioner-facing interface enabled by the EMR utility provides diagnosis forms in which the medical practitioner may enter current athlete parameters, such as, for example, responses to interview questions. In embodiments, some or all of these fields may be pre-populated based on available data in the athlete's EMR, including baseline data. As shown in FIG. 7B, the medical practitioner may enter further data concerning the athlete and the relevant incident, including, for example, date of injury, sport being played during which the incident occurred, and whether the athlete suffered an impact to his head. Further templates are shown in FIGS. 7C and 7D. As shown in FIGS. 7D and 7E, the templates may comprise radial fields which the medical practitioner may select to indicate her diagnosis of the athlete's condition, as well as required follow-up actions and treatment recommendations.

In embodiments, the medical practitioner-facing interface further displays tables and/or charts, as shown in FIG. 7F, to compare and tabulate scores for the athlete, based, for example, on a comparison of the athlete's present condition with the athlete's baseline parameters. The EMR utility performs data analysis, calculations and graphing to cause a user device to display tables and/or charts.

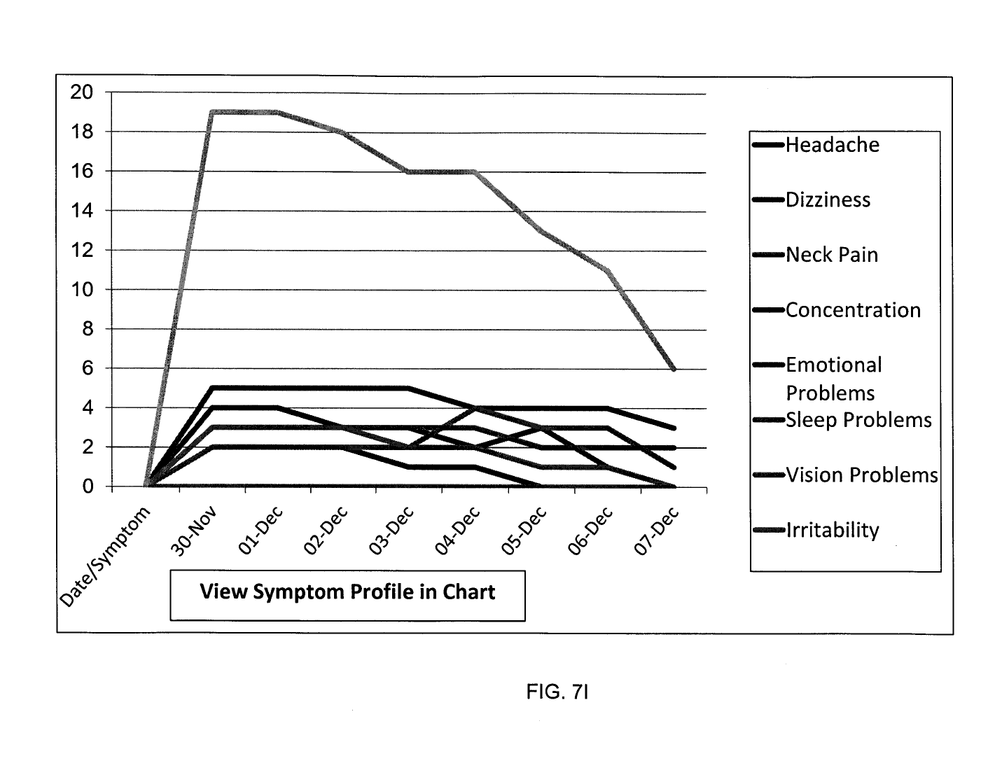

As shown in FIGS. 7G and 71, the medical practitioner may further define follow-up actions required in order for the athlete's condition to be treated, including, for example, referrals to specialists, activity restrictions, and treatment requirements. The selection of follow-up actions may automatically alter the functionality of the athlete-, parent- and/or coach/trainer-facing EMR sub-utility. For example, if the medical practitioner has selected daily follow-up, the athlete-facing EMR sub-utility may cause athlete reporting and training modules to be displayed on the athlete's device.

In further embodiments, the EMR utility may push notifications to concerned users' devices, such as, for example, the athlete's device, the athlete's parents' device, and/or the coach's or trainer's device.

In embodiments, the system enables a healthcare provider to develop a training and treatment plan for the athlete. The system may then push the training plan or modules thereof to the athlete at suitable time intervals. Further, the system enables the athlete or a third party, such as, for example, the athlete's trainer or parent, to report progress in completing the training plan, daily activities, daily symptom logs and scores to the medical provider.

In an exemplary scenario, a healtchare practitioner may select, in the medical practitioner-facing sub-utility on her user device, a treatment plan for an athlete to undertake. The medical practitioner may also select that the athlete's parents, coach and/or trainer should receive notifications of the treatment plan, as well as requests to report athlete progress. The medical practitioner's user device transmits the selections to the EMR server, which annotates the athlete's record in the EMR database with data relevant to the treatment plan.

The EMR utility then pushes notifications to the athlete, his parents, and coach and/or trainer. There may be an initial notification, for example, that the athlete should limit his play and commence treatment. Further, periodic notifications may be pushed to the users' devices over the course of the athlete's treatment plan, including, for example, instructions to conduct training, requests for reports and updates, and status updates so that the parties can monitor the athlete's progress throughout the treatment plan.

Notifications may cause the user's device to display forms for data entry. For example, an athlete may receive on his device a notification requesting whether he has performed an element of the training plan on a given day. The notification may cause his device to present a form with reporting fields, such as, for example, radial icons and text entry fields. For example, as shown in FIG. 6J and as described above, the athlete may select radials corresponding to his physical condition for a given date and/or time. When the athlete selects and enters data into the fields using suitable input devices on his user device, the data from those fields is then transmitted to the EMR server. The EMR server annotates the patient's EMR record in the EMR database. The EMR server may also forward the data to the medical practitioner's user device for presentation to the medical practitioner.

It will be appreciated that the medical provider may thereby monitor the athlete's progress. As shown in FIG. 71, the medical practitioner-facing EMR sub-utility may cause the medical practitioner's device to selectively display tabulated reports of the patient's symptoms and progress. For example, the patient's symptoms may be displayed in any suitable type of chart, as tracked over time, as shown. The EMR utility generates the tables by reading and tabulating patient data from the EMR server. The EMR utility then causes user devices to display the tables.

The various interested users enter progress reports, either voluntarily, or upon prompting from the EMR utility. These reports are associated to the athlete's EMR data, as before, with the athlete's token and the athlete's associated anonymous identifier, and are received by the EMR server and added to the athlete's EMR in the EMR database.

Finally, once the medical practitioner has reviewed the athlete's progress, the medical practitioner may annotate the patient's EMR through the medical practitioner sub-utility to indicate that the athlete may, for example, resume full or partial physical activity, or that the athlete is required to attend further follow-up sessions, or undergo further treatments, or that no further follow-up is required. The EMR utility may then push a notification of the medical practitioner's decision to the devices of the athlete, his parents, coach and/or trainer and/or teacher.

In various exemplary scenarios, a coach, teacher, or other user of the EMR utility may compile a list of patients or athletes on a roster, and view the list of athletes in conjunction with status identification for each. The user may thus see, at a glance, which athlete is fit for which level of cognitive or physical activity during a training session. As shown in FIG. 5H-J, the coach facing EMR utility may display the roster so that the names of the athletes are accompanied by an icon or text field showing which activities the user may carry out. The coach facing EMR utility may further display a field which the user may select to request that any athlete's treatment level be revised by a healthcare provider. The request will be shown to the healthcare provider via the healthcare provider facing EMR utility. The status of the request may be shown in a pop-down or other expanded menu surrounding each athlete's name.

In embodiments, the EMR utility may further generate automatically populated summary reporting letters based on the athlete's parameters and issue the reporting letters to the email or device of the athlete or other concerned users. For example, when the medical practitioner determines that the patient is fit to return to full contact physical activity without further follow-up, the EMR utility may generate and forward a reporting letter to the athlete, his parents and his coach and/or trainer advising them of the medical practitioner's determination. In embodiments, upon such a determination, the EMR server may decrease the activity level and capabilities of the athlete-, parent- and coach- and/or trainer-facing sub-utilities. For example, the athlete-facing sub-utility may only display basic information, such that training and advanced reporting modules may be disabled.

Consolidated EMRs in the EMR database may comprise data useful for research purposes. Further, third party researchers may value the data contained in the EMR database. The EMR utility may therefore anonymise EMR data for transmission to third party researchers. In embodiments, the EMR utility retrieves from the EMR database athletes' EMRs and transmits the data therein to third party researchers. The EMR utility anonymises the data by disassociating the data from any identifying information, including the anonymous unique identifier and the anonymous token and transmits the disassociated data to a researcher device upon request. EMR data may be anonymised further by aggregating data from a plurality of EMRs for a plurality of athletes.

Although the foregoing has been described with reference to certain specific embodiments, various modifications thereto will be apparent to those skilled in the art without departing from the spirit and scope of the invention as outlined in the appended claims. The entire disclosures of all references recited above are incorporated herein by reference.

What is claimed is:

1. A system for providing a plurality of users with varying levels of access to stored medical record data for a plurality of patients, the system comprising:
a database to store the medical record data and a plurality of access permissions, the database identifying each patient's medical record data by an anonymous identifier for the patient, the anonymous identifier having an associated anonymous token; and
a server computer communicatively coupled to the database and accessible by a plurality of client computing devices, the server computer being configured to, upon receiving from one of the client computing devices a request containing a user identity of one of the users and the anonymous token of one of the patients:
identify, from the user identity, to which one of a plurality of classes of the users the user belongs;
retrieve an access permission for the class from amongst the plurality of access permissions, each access permission defining which subset of each patient's medical record data can be read or written by the class to the medical record data identified by the anonymous identifier associated to the anonymous token in the request; and
exchange medical record data identified in the request between the computing device and the database according to the access permission and writing any data from the computing device to the database.

2. The system of claim 1, wherein a first class from the plurality of classes comprises coaches, teachers or trainers, and the access permission for the first class permits any user from the first class to write an injury report to the medical record data identified by the anonymous identifier associated to the anonymous token in the request.

3. The system of claim 1, wherein the anonymous token is discernible from a physical tag attachable to the patient or belongings of the patient.

4. The system of claim 3, wherein:
the physical tag displays a visual code applied to the surface of the physical tag; and
the computing device of the user is configured to read the code and discern the anonymous token from the code.

5. The system of claim 4, wherein the visual code is a QR code, a UPC code, or an alphanumeric code.

6. The system of claim 4, wherein:
the physical tag emits an RFID; and
the computing device of the user is configured to read the RFID and discern the token from the RFID.

7. The system of claim 1, wherein a first class from the plurality of classes comprises coaches, teachers or trainers, and the access permission for the first class permits any user from the first class to build a roster comprising a plurality of patients by entering the anonymous token for each patient in the roster, and to simultaneously receive on the computing device of the user a status indication from the medical record data for each of the plurality of patients in the roster, each status indication indicating a stage of recovery of each patient.

8. The system of claim 7, wherein the computing device of the user is configured to display a list of the patients in the roster alongside the status indication of each patient.

9. The system of claim 7, wherein the status indication for each user is discernible to indicate a permissible level of activity for the user.

10. The system of claim 9, wherein a second class from amongst the plurality of classes comprises medical practitioners, and the server computer is further configured to select the permissible level of activity based on the stage of recovery, upon a user from the second class selecting the stage of recovery.

11. The system of claim 10, wherein the access permission for the first class further permits a user from the first class to submit a request for reassessment for any patient in the roster to the database, and wherein the server computer is further configured to transmit the request for reassessment to any user from the second class who is permitted to see the request.

12. The system of claim 1, wherein a first class from the plurality of classes comprises coaches, teachers or trainers, a second class from the plurality of classes comprises patients, and a third class from the plurality of classes comprises healthcare providers, and the access permission for the first class and the second class permits any user belonging to the first class or the second class to contribute reporting to the medical record data upon the user receiving and agreeing to a request for the reporting from another user belonging to the third class.

13. The system of claim 1, wherein the server is further configured to disassociate the medical record data from any identifying information in the data, aggregate the medical record data across the plurality of patients whose medical record data is stored in the database, and provide the aggregated medical record data to one of the plurality of computing devices.

14. A computer-implemented method for providing a plurality of users with varying levels of access to stored medical record data for a plurality of patients, the method comprising:
storing medical record data and a plurality of access permissions in a database, the database identifying the medical record data for each patient by an anonymous identifier for the patient, the anonymous identifier having an associated anonymous token; and
by a server computer, upon receiving from one of a plurality of client computing devices a request containing a user identity of one of the users and the anonymous token of one of the patients:
identifying, from the user identity, to which one of a plurality of classes of the users the user belongs;
retrieving an access permission for the class from amongst the plurality of access permissions, each access permission defining which subset of each patient's medical record data can be read or written by the class to the medical record data identified by the anonymous identifier or the anonymous token; and
exchanging medical record data identified in the request between the computing device and the database according to the access permission and writing any data from the computing device to the database.

15. The computer-implemented method of claim 14, wherein a first class from the plurality of class comprises coaches, teachers or trainers, and the access permission for the first class permits any user from the first class to write an injury report to the medical record data identified by the anonymous identifier associated to the anonymous token in the request.

16. The computer-implemented method of claim 14, wherein the anonymous token is discernible from a physical tag attachable to the patient or belongings of the patient.

17. The computer-implemented method of claim 16, wherein:
the physical tag displays a visual code applied to the surface of the physical tag; and
the computing device of the user is configured to read the code and discern the token from the code.

18. The computer-implemented method of claim 17, wherein the visual code is a QR code, a UPC code, or an alphanumeric code.

19. The computer-implemented method of claim 18, wherein:
the physical tag emits an RFID; and
the computing device of the user is configured to read the RFID and discern the anonymous token from the RFID.

20. The computer-implemented method of claim 14, wherein a first class from the plurality of classes comprises coaches, teachers or trainers, the access permission for the first class permitting any user from the first class to build a roster comprising a plurality of patients by entering the token for each patient in the roster, and simultaneously receiving on the computing device of the user a status indication from the medical record data for each of the plurality of patients in the roster, each status indication indicating a stage of recovery of each patient.

21. The computer-implemented method of claim 20, wherein the computing device of the user is configured to display a list of the patients in the roster alongside the status indication of each patient based on the status indication.

22. The computer-implemented method of claim 20, wherein the status indication for each user is discernible to indicate a permissible level of activity for the user.

23. The computer-implemented method of claim 22, wherein a second class from amongst the plurality of classes comprises medical practitioners, and the server computer further selecting the permissible level of physical or cognitive activity based on the stage of recovery, upon a user from the second class selecting the stage of recovery.

24. The computer-implemented method of claim 23, the access permission for at least the first class further permitting a user from the first class to submit a request for reassessment for any patient in the roster to the database, and the server computer further transmitting the request for reassessment to any user who from the second class who is permitted to see the request.

25. The computer-implemented method of claim 14, wherein a first class from the plurality of class comprises coaches, teachers or trainers, a second class from the plurality of classes comprises patients, and a third class from the plurality of classes comprises medical practitioners, and the access permission for the first class and the second class permits any user from the first class or the second class to contribute reporting to the medical record data upon the user receiving and agreeing to a request for the reporting from another user belonging to the third class.

26. The computer-implemented method of claim 14, the server computer disassociating the medical record data from any identifying information in the data, aggregating the medical record data across the plurality of patients whose medical record data is stored in the database, and providing the aggregated medical record data to one of the plurality of computing devices.
